(19) United States
(12) Patent Application Publication
(10) Pub. No.: US 2025/0287349 A1
(43) Pub. Date: Sep. 11, 2025

(54) METHOD AND DEVICE FOR DETERMINING MOBILITY STATE IN NEXT-GENERATION MOBILE COMMUNICATION SYSTEM

(71) Applicant: Samsung Electronics Co., Ltd., Gyeonggi-do (KR)

(72) Inventors: Sangyeob JUNG, Gyeonggi-do (KR); Anil AGIWAL, Gyeonggi-do (KR)

(21) Appl. No.: 18/862,041

(22) PCT Filed: May 12, 2023
(86) PCT No.: PCT/KR2023/006473

§ 371 Date: Oct. 31, 2024

(30) Foreign Application Priority Data
May 12, 2022 (KR) 10-2022-0058486

(51) Int. Cl. H04W 64/00; H04W 76/30

(52) U.S. Cl. CPC H04W 64/006; H04W 76/30

(57) ABSTRACT

The disclosure relates to a mobile communication system terminal and base station operation and, specifically, to a communication technique for determining a mobility state, and a system therefor. A method performed by a terminal in a wireless communication system of the disclosure comprises the steps of: receiving, from a base station, a message including a parameter for determining a mobility state of the terminal; identifying, from the message, information for determination of a mobility state of an uncrewed aerial vehicle (UAV) terminal; and determining the mobility state of the terminal on the basis of the information for determination of the mobility state of the UAV terminal.

### TECHNICAL FIELD

The disclosure relates to the operations of a terminal and a base station in a mobile communication system, and particularly to a method and device for determining a mobility state.

### BACKGROUND ART

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6^{th} generation (6G) mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra-reliable low latency communications (URLLC), and massive machine-type communications (mMTC), there has been ongoing standardization regarding beamforming and massive multi-input multi-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR UE power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures. i.e., 1b-step random access channel (RACH) for NR. There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

As described above, with the development of mobile communication systems, various services can be provided, and a scheme for effectively providing such services according to the mobility state of a terminal is required.

### DISCLOSURE

### Technical Problem

The disclosure relates to a wireless communication system and the operations of a terminal and a base station in a mobile communication system in relation to a mobility state determination.

### Technical Solution

According to an embodiment of the disclosure, a method performed by a terminal in a wireless communication system may include receiving, from a base station, a message including parameters for determining a mobility state of the terminal, identifying, in the message, information for determining the mobility state of an uncrewed aerial vehicle (UAV) terminal; and determining the mobility state of the terminal based on the information for determining the mobility state of the UAV terminal.

According to an embodiment, the message may include a first parameter set for determining the mobility state of a normal terminal and a second parameter set for determining the mobility state of the UAV terminal.

According to an embodiment, the message may include a parameter set for determining the mobility state of a normal terminal and a scaling factor for determining the mobility state of the UAV terminal, and the scaling factor for determining the mobility state of the UAV terminal may be applied to the parameter set.

According to an embodiment, the message may include at least one of a radio resource control (RRC) connection release message or a system information block (SIB) message.

According to an embodiment, the method may further include transmitting the determined mobility state of the terminal to the base station.

According to another embodiment of the disclosure, a terminal in a wireless communication system may include a transceiver transmitting and receiving a signal, and a controller configured to receive, from a base station, a message including parameters for determining a mobility state of the terminal, to identify, in the message, information for determining the mobility state of an uncrewed aerial vehicle (UAV) terminal, and to determine the mobility state of the terminal based on the information for determining the mobility state of the UAV terminal.

According to yet another embodiment of the disclosure, a method performed by a base station in a wireless communication system may include transmitting, to a terminal, a message including parameters for determining a mobility state of the terminal; and receiving, from the terminal, the mobility state of the terminal, wherein the received mobility state of the terminal is determined based on information for determining the mobility state of an uncrewed aerial vehicle (UAV) terminal in the message by the terminal.

According to still another embodiment of the disclosure, a base station in a wireless communication system may include a transceiver transmitting and receiving a signal, and a controller configured to transmit, to a terminal, a message including parameters for determining a mobility state of the terminal, and to receive, from the terminal, the mobility state of the terminal, wherein the received mobility state of the terminal is determined based on information for determining the mobility state of an uncrewed aerial vehicle (UAV) terminal in the message by the terminal.

### Advantageous Effects

In the case where a terminal moving at a high speed follows a conventional mobility state determination, it may enter a medium mobility state or a high mobility state much later despite the speed being fast. However, according to embodiments of the disclosure, the terminal can enter the medium mobility state or the high mobility state more quickly.

### DESCRIPTION OF DRAWINGS

FIG. 1A is a diagram illustrating the structure of an LTE system according to an embodiment of the disclosure.

FIG. 1B is a diagram illustrating a radio protocol structure in an LTE system according to an embodiment of the disclosure.

FIG. 1C is a diagram illustrating the structure of a next-generation mobile communication system according to an embodiment of the disclosure.

FIG. 1D is a diagram illustrating a radio protocol structure of a next-generation mobile communication system according to an embodiment of the disclosure.

FIG. 1E is a diagram illustrating that a UE in RRC idle mode (RRC_IDLE) or RRC inactive state (RRC_INACTIVE) performs a cell reselection evaluation procedure in a next-generation mobile communication system according to an embodiment of the disclosure.

FIG. 1G is a flowchart illustrating a process in which a UE reports a mobility state to an NR base station in a typical NR mobile communication system according to an embodiment of the disclosure.

FIG. 1H is a flowchart illustrating a process in which a UE reports a mobility state to an NR base station in a next-generation mobile communication system according to an embodiment of the disclosure.

FIG. 1H is a flowchart illustrating a process in which a UE reports a mobility state to an NR base station in an NR system proposed according to an embodiment of the disclosure.

FIG. 1I is a flowchart illustrating a process in which a UE reports a mobility state to an NR base station in a next-generation mobile communication system according to an embodiment of the disclosure.

FIG. 1J is a flowchart illustrating a process in which a UE reports a mobility state to an NR base station in a next-generation mobile communication system according to an embodiment of the disclosure.

FIG. 1K is a flowchart illustrating a process in which a UE reports a mobility state to an NR base station in a next-generation mobile communication system according to an embodiment of the disclosure.

FIG. 1L is a flowchart illustrating a process in which a UE reports flight path information to an NR base station through an RRC connection resume procedure in a next-generation mobile communication system according to an embodiment of the disclosure.

FIG. 1M is a block diagram illustrating the structure of a UE according to an embodiment of the disclosure.

FIG. 1N is a block diagram illustrating the structure of an NR base station according to an embodiment of the disclosure.

### MODE FOR DISCLOSURE

Hereinafter, the operation principle of the disclosure will be described in detail in conjunction with the accompanying drawings. In the following description of the disclosure, a detailed description of known functions or configurations incorporated herein will be omitted when it may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description of the disclosure, a detailed description of known functions or configurations incorporated herein will be omitted when it may make the subject matter of the disclosure unnecessarily unclear. Hereinafter, embodiments of the disclosure will be described with reference to the attached drawings.

In the following description, terms for identifying access nodes, terms With reference to network entities, terms With reference to messages, terms With reference to interfaces between network entities, terms With reference to various identification information, and the like are illustratively used for the sake of convenience. Therefore, the disclosure is not limited by the terms as used below, and other terms With reference to subjects having equivalent technical meanings may be used.

In the following description, the disclosure will be described using terms and names defined in the 3rd generation partnership project long term evolution (3GPP LTE) standards for the convenience of description. However, the disclosure is not limited by these terms and names, and may be applied in the same way to systems that conform other standards. In the disclosure, the term eNB may be interchangeably used with the term gNB. That is, a base station described as eNB may indicate gNB.

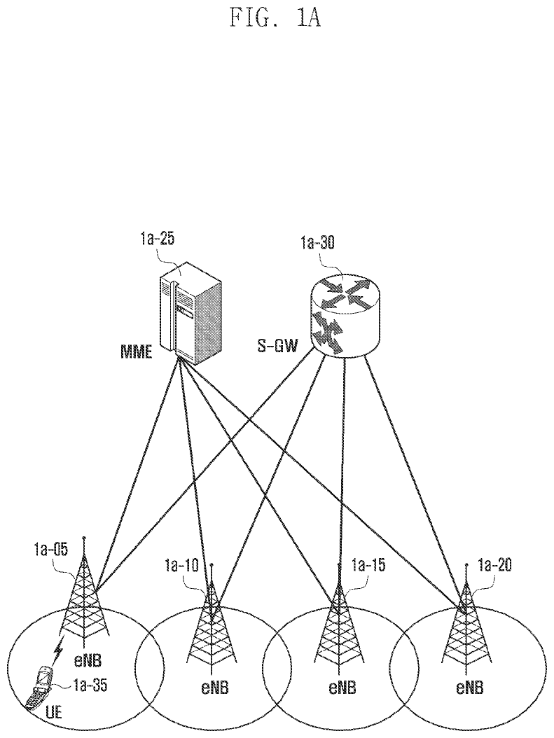

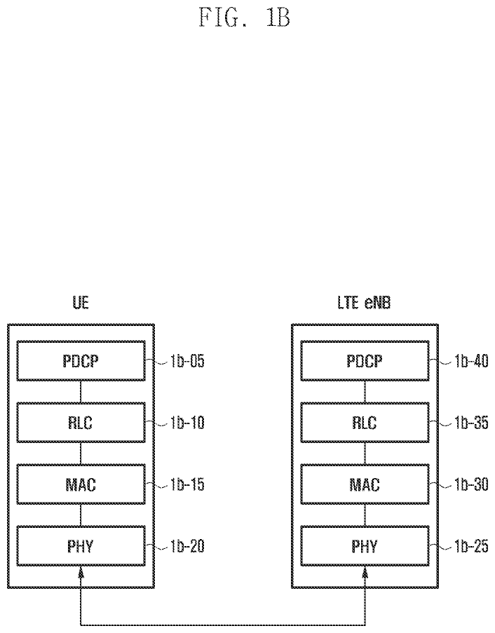

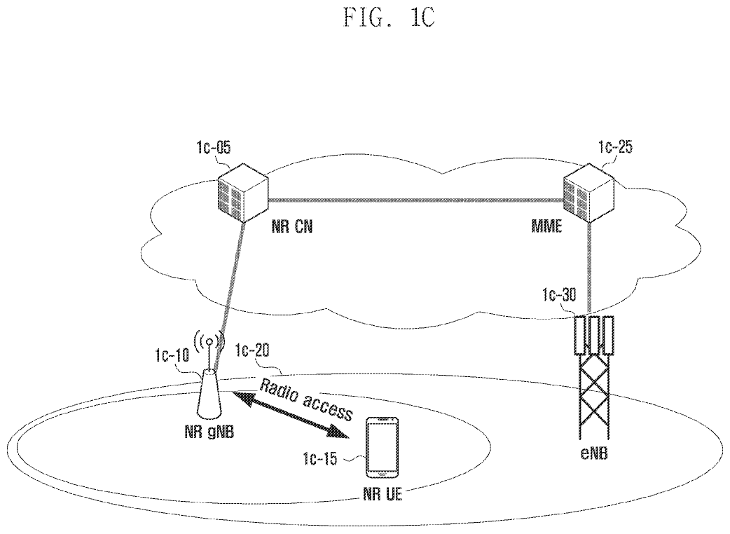

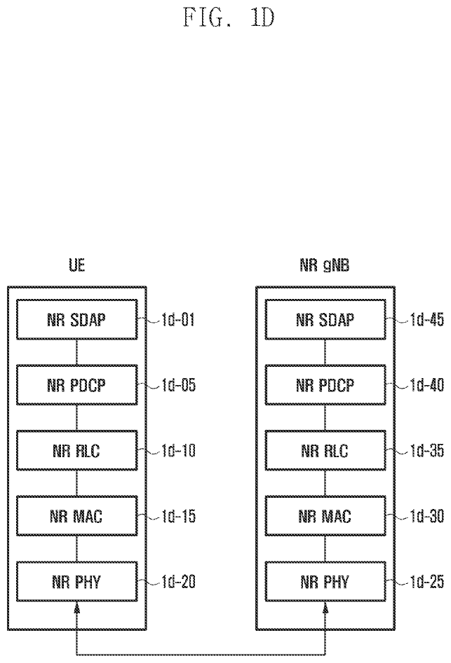

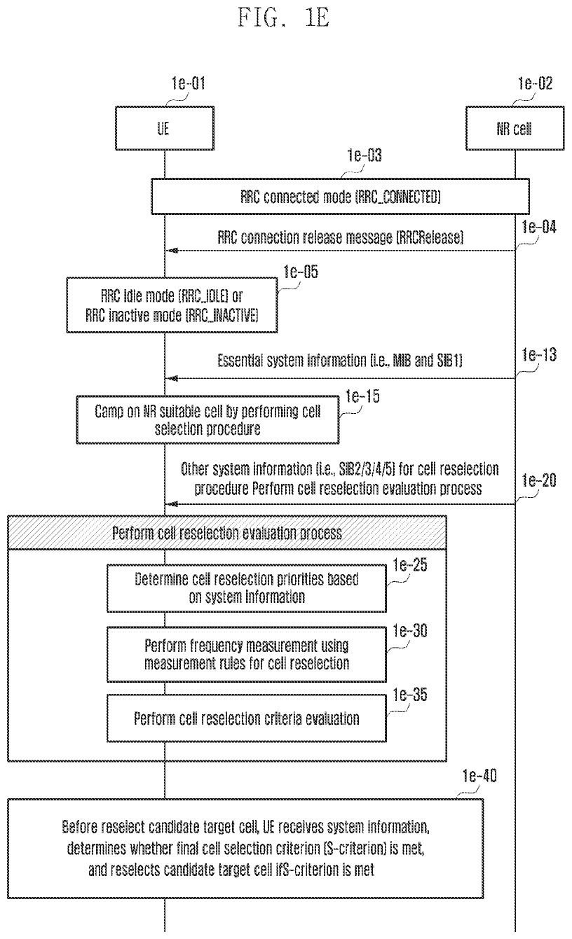

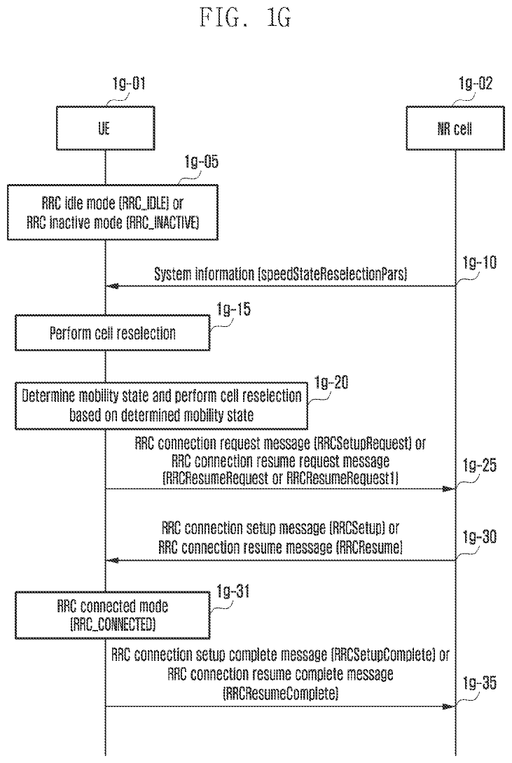

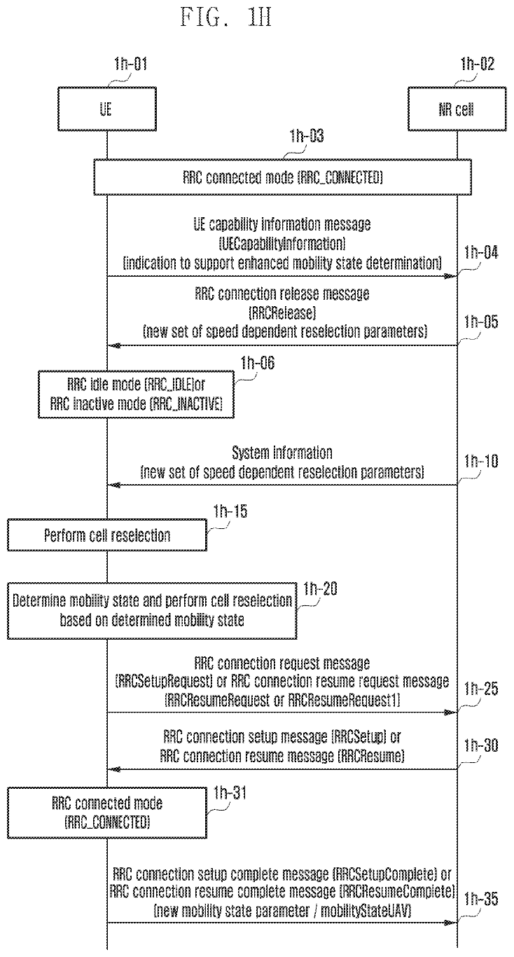

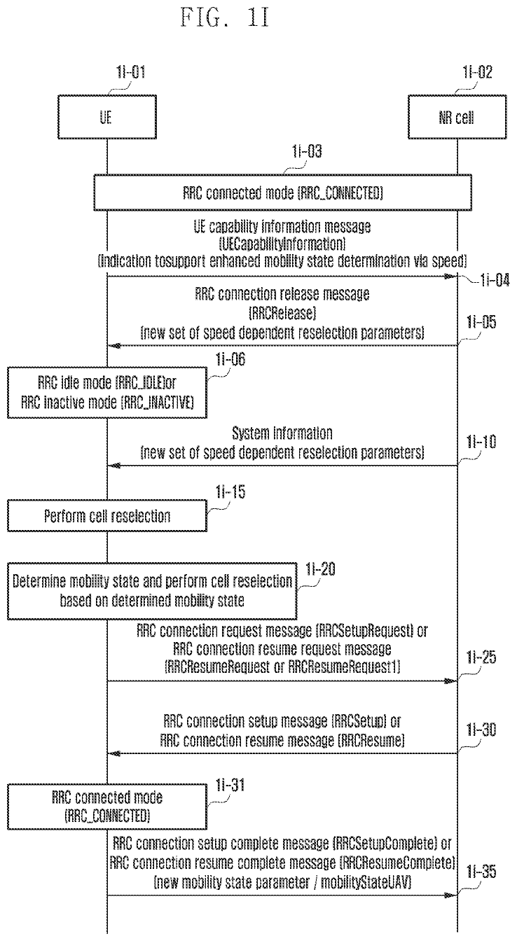

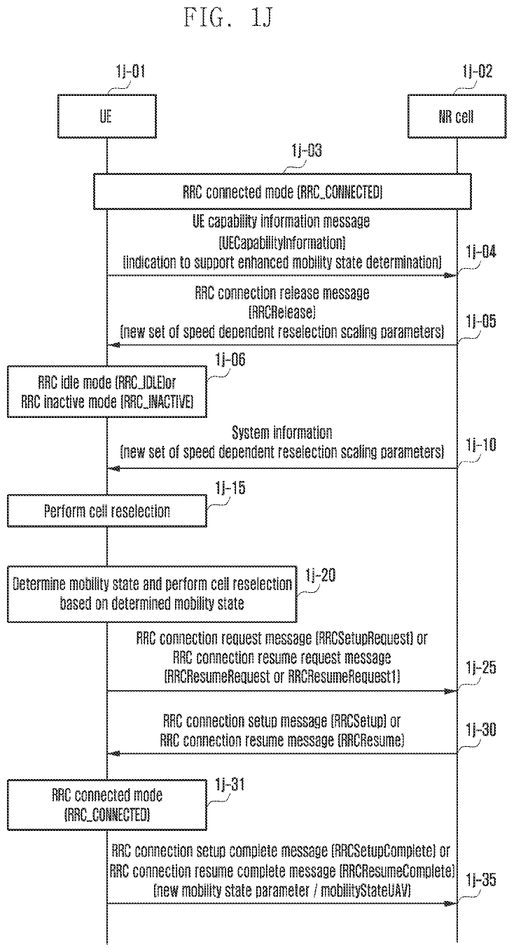

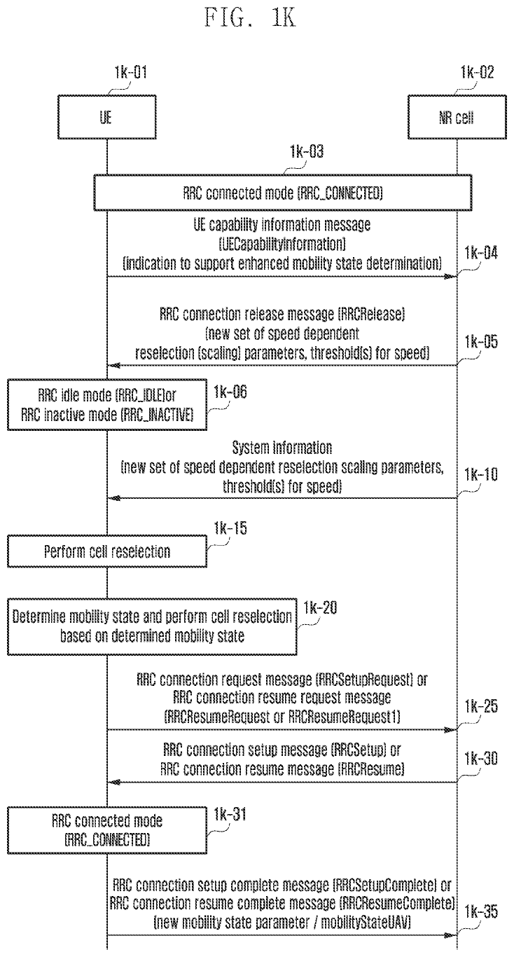

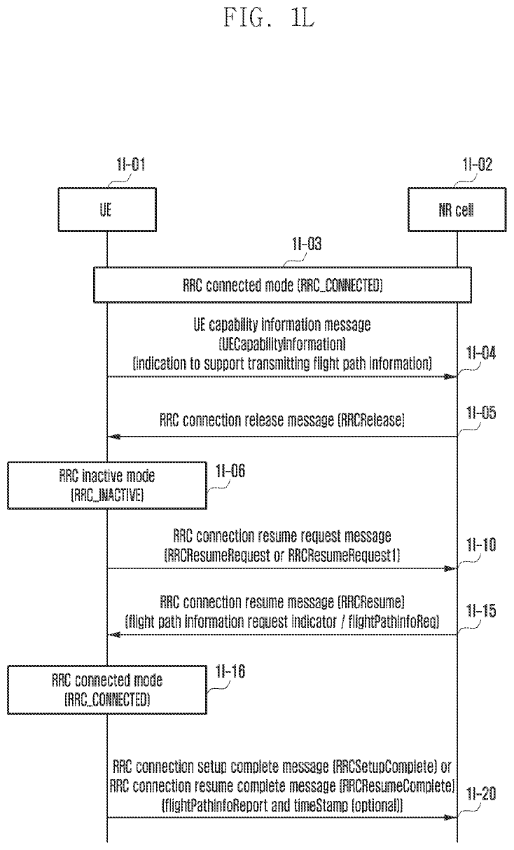

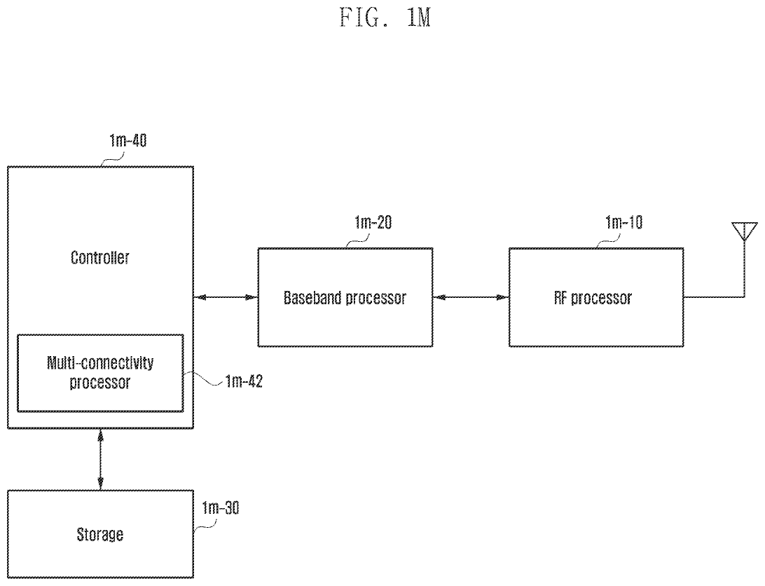

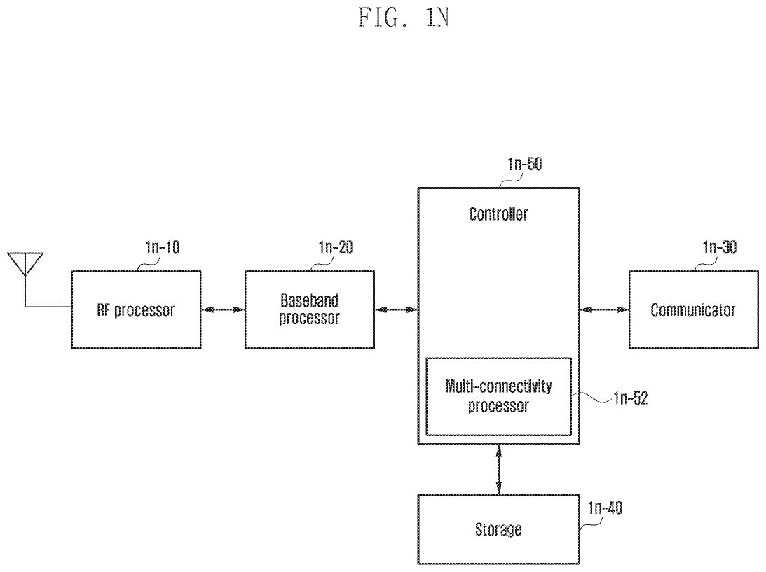

FIG. 1A is a diagram illustrating the structure of an LTE system according to an embodiment of the disclosure.

With reference to FIG. 1A, a radio access network of the LTE system may include next-generation evolved node Bs (hereinafter, referred to as evolved node Bs (eNBs), Node Bs, or base stations) 1a-05, 1a-10, 1a-15 and 1a-20, a mobility management entity (MME) 1a-25, and a serving-gateway (S-GW) 1a-30. A user equipment 1a-35 (hereinafter, referred to as a UE or a terminal) may access an external network through the eNBs 1a-05 to 1a-20 and the S-GW 1a-30.

In FIG. 1A, the eNBs 1a-05 to 1a-20 may correspond to conventional Node Bs of a universal mobile telecommunications system (UTMS). The eNB is connected to the UE 1a-35 through a radio channel, and may perform a more complicated role than the conventional node B. In the LTE system, since all user traffic including a real time service such as a voice over IP (VoIP) through an Internet protocol are serviced through a shared channel, an apparatus for collecting and scheduling status information on buffer statuses of UEs, available transmission power status, and channel statuses is required, and the eNBs 1a-05 to 1a-20 may serve as this apparatus. In general, one eNB may control a plurality of cells. For example, in order to implement a transmission rate of 100 Mbps, the LTE system may use orthogonal frequency-division multiplexing (OFDM) as a wireless access technology in a bandwidth of 20 MHz. Furthermore, an adaptive modulation and coding (AMC) scheme of determining a modulation scheme and a channel-coding rate may be applied depending on the channel status of the UE. The S-GW 1a-30 is a device for providing a data bearer, and may generate or remove the data bearer under a control of the MME 1a-25. The MME is a device for performing not only a function of managing the mobility of the UE but also various control functions, and may be connected to the plurality of eNBs.

FIG. 1B is a diagram illustrating a radio protocol structure in an LTE system according to an embodiment of the disclosure.

With reference to FIG. 1B, the UE and the eNB may include packet data convergence protocols (PDCPs) 1b-05 and 1b-40, radio link controls (RLCs) 1b-10 and 1b-35, medium access controls (MACs) 1b-15 and 1b-30, respectively, in the radio protocol of the LTE system. The packet data convergence protocols (PDCPs) 1b-05 and 1b-40 may perform an operation of compressing/reconstructing an IP header. The main functions of the PDCP are described below.
Header compression and decompression function (Header compression and decompression: ROHC only)
User data transmission function (transfer of user data)
Sequential delivery function (in-sequence delivery of upper-layer PDUs at PDCP reestablishment procedure for RLC AM)
Sequence re-arrangement function (For split bearers in DC (only support for RLC AM): PDCP PDU routing for transmission and PDCP PDU reordering for reception)
Duplicate detection function (duplicate detection of lower-layer SDUs at PDCP reestablishment procedure for RLC AM)
Retransmission function (retransmission of PDCP SDUs at handover and, for split bearers in DC, of PDCP PDUs at PDCP data recovery procedure, for RLC AM)
Ciphering and deciphering function (Ciphering and deciphering)
Timer-based SDU removal function (timer-based SDU discard in uplink)

The radio link controls (RLCs) 1b-10 and 1b-35 reconfigure the PDCP packet data unit (PDU) to be the proper size and perform an ARQ operation. The main functions of the RLC are summarized below.
Data transmission function (transfer of upper-layer PDUs)
ARQ function (Error Correction through ARQ (only for AM data transfer))
Concatenation, segmentation, and reassembly function (Concatenation, segmentation and reassembly of RLC SDUs (only for UM and AM data transfer))
Re-segmentation function (re-segmentation of RLC data PDUs (only for AM data transfer))
Reordering function (reordering of RLC data PDUs (only for UM and AM data transfer))
Duplication detection function (duplicate detection (only for UM and AM data transfer))
Error detection function (protocol error detection (only for AM data transfer))
RLC SDU deletion function (RLC SDU discard (only for UM and AM data transfer))
RLC reestablishment function (RLC reestablishment)

The MACs 1b-15 and 1b-30 are connected with various RLC layer devices configured in one UE, and perform an operation for multiplexing RLC PDUs to the MAC PDU and de-multiplexing the RLC PDUs from the MAC PDU. The main functions of the MAC are summarized below
Mapping function (Mapping between logical channels and transport channels)
Multiplexing and demultiplexing function (Multiplexing/demultiplexing of MAC SDUs belonging to one or multiple different logical channels into/from transport blocks (TB) delivered to/from the physical layer on transport channels)
Scheduling information report function (scheduling information reporting)
HARQ (hybrid automatic repeat request) function (error correction through HARQ)
Logical channel priority control function (priority handling between logical channels of one UE)
UE priority control function (priority handling between UEs by means of dynamic scheduling)
MBMS service identification function (MBMS service identification)
Transport format selection function (transport format selection)
Padding function (padding)

The PHY layers 1b-20 and 1b-25 may perform an operation for channel-coding and modulating higher-layer data to generate an OFDM symbol and transmitting the OFDM symbol through a radio channel or demodulating and channel-decoding the OFDM symbol received through the radio channel and transmitting the demodulated and channel-decoded OFDM symbol to the higher layer.

FIG. 1C is a diagram illustrating the structure of a next-generation mobile communication system according to an embodiment of the disclosure.

With reference to FIG. 1C, a radio access network of the next-generation mobile communication system (hereinafter, referred to as NR or 6G) may include a next-generation base station 1c-10 (new radio node B, hereinafter, referred to as an NR gNB or an NR base station) and a new radio core network (NR CN) 1c-05. A user terminal 1c-15 (hereinafter, referred to as a new radio user equipment (NR UE) or a terminal) may access an external network through the NR gNB 1c-10 and the NR CN 1c-05.

In FIG. 1C, the NR gNB 1c-10 may correspond to an evolved Node B (eNB) in a conventional LTE system. The NR gNB may be connected to the NR UE 1c-15 through a radio channel and may provide better service than the conventional node B. Since all user traffic is served through a shared channel in the next-generation mobile communication system, a device for collecting and scheduling status information of buffer statuses, available transmission power statuses, and channel statuses of UEs is required, and corresponds to the NR NB 1c-10. One NR gNB may generally control a plurality of cells. The base station may have a bandwidth wider than the conventional maximum bandwidth in order to implement super-high-speed data transmission compared to conventional LTE, may apply orthogonal frequency-division multiplexing (OFDM) through radio-access technology, and may further apply beamforming technology. Further, an adaptive modulation and coding (AMC) scheme of determining a modulation scheme and a channel-coding rate may be applied depending on the channel status of the NR UE. The NR CN 1c-05 may perform a function of supporting mobility, configuring a bearer, and configuring QoS. The NR CN is a device for performing a function of managing the mobility of the NR UE and various control functions, and may be connected to a plurality of base stations. Further, the next-generation mobile communication system may be linked to the conventional LTE system, and the NR CN may be connected to an MME 1c-25 through a network interface. The MME may be connected to an eNB 1c-30, which is a conventional base station.

FIG. 1D is a diagram illustrating a radio protocol structure of a next-generation mobile communication system according to an embodiment of the disclosure.

FIG. 1D is a diagram illustrating a radio protocol structure of a next-generation mobile communication system to which the disclosure can be applied.

With reference to FIG. 1D, the UE and the MR base station may include NR SDAPs 1d-01 and 1d-45, NR PDCPs 1d-05 and 1d-40, NR RLCs 1d-10 and 1d-35, and NR MACs 1d-15 and 1d-30 in the radio protocol of the next-generation mobile communication system.

The main functions of the NR SDAPs 1d-01 and 1d-45 may include some of the following functions.
User data transmission function (transfer of user-plane data)
Function of mapping QoS flow and a data bearer for uplink and downlink (mapping between a QoS flow and a DRB for both DL and UL)
Function of marking a QoS flow ID for uplink and downlink (marking QoS flow ID in both DL and UL packets)
Function of mapping reflective QoS flow to a data bearer for uplink SDAP PDUs (reflective QoS flow to DRB mapping for the UL SDAP PDUs)

With respect to the SDAP layer device, the UE may receive a configuration as to whether to use a header of the SDAP layer device or a function of the SDAP layer device for each PDCP layer device, each bearer, or each logical channel through an RRC message. If the SDAP header is configured, a 1-bit indicator of NAS reflective QoS of the SDAP header and a 1 bit-indicator of AS reflective QoS may indicate that the UE updates or reconfigures information on mapping of QoS flow and a data bearer in uplink and downlink. The SDAP header may include QoS flow ID information indicating the QoS. The QoS information may be used as data-processing-priority or scheduling information to support a seamless service.

The main functions of the NR PDCPs 1d-05 and 1d-40 may include some of the following functions.
Header compression and decompression function (Header compression and decompression: ROHC only)
User data transmission function (transfer of user data)
Sequential delivery function (in-sequence delivery of upper-layer PDUs)
Non-sequential delivery function (out-of-sequence delivery of upper-layer PDUs)
Reordering function (PDCP PDU reordering for reception)
Duplicate detection function (duplicate detection of lower-layer SDUs)
Retransmission function (retransmission of PDCP SDUs)
Ciphering and deciphering function (Ciphering and deciphering)
Timer-based SDU removal function (timer-based SDU discard in uplink)

The reordering function of the NR PDCP device is a function of sequentially reordering PDCP PDUs received by a lower layer on the basis of a PDCP Sequence Number (SN), and may include a function of sequentially transferring the reordered data to a higher layer, a function of directly transmitting the reordered data without regard to the order, a function of recording PDCP PDUs lost due to the reordering, a function of reporting statuses of the lost PDCP PDUs to a transmitting side, and a function of making a request for retransmitting the lost PDCP PDUs.

The main functions of the NR RLCs 1d-10 and 1d-35 may include some of the following functions.
Data transmission function (transfer of upper-layer PDUs)
Sequential delivery function (in-sequence delivery of upper-layer PDUs)
Non-sequential delivery function (out-of-sequence delivery of upper-layer PDUs)
ARQ function (error correction through ARQ)
Concatenation, segmentation, and reassembly function (concatenation, segmentation and reassembly of RLC SDUs)
Re-segmentation function (re-segmentation of RLC data PDUs)
Reordering function (reordering of RLC data PDUs)
Duplicate detection function (duplicate detection)
Error detection function (protocol error detection)
RLC SDU deletion function (RLC SDU discard)
RLC reestablishment function (RLC reestablishment)

The sequential delivery function (In-sequence delivery) of the NR RLC device is a function of sequentially transferring RLC PDUs received from a lower layer to a higher layer, and may include, when one original RLC SDU is divided into a plurality of RLC SDUs and then received, a function of reassembling and transmitting the RLC SDUs, a function of reordering the received RLC PDUs on the basis of an RLC Sequence Number (SN) or a PDCP SN, a function of recording RLC PDUs lost due to the reordering, a function of reporting statuses of the lost RLC PDUs to a transmitting side, a function of making a request for retransmitting the lost RLC PDUs, if there is a lost RLC SDU, a function of sequentially transferring only RLC SDUs preceding the lost RLC SDU to the higher layer if a predetermined timer expires when there is a lost RLC SDU, a function of sequentially transferring all RLC SDUs received before the timer starts to the higher layer, or if a predetermined timer expires when there is a lost RLC SDU, and a function of sequentially transferring all RLC SDUs received up to that point in time to the higher layer. Further, the NR RLC device may process the RLC PDUs sequentially in the order of reception thereof (according to an arrival order regardless of a serial number or a sequence number) and may transfer the RLC PDUs to the PDCP device regardless of the sequence thereof (out-of-sequence delivery). In the case of segments, the NR RLC device may receive segments that are stored in the buffer or are to be received in the future, reconfigure the segments to be one RLC PDU, process the RLC PDU, and then transmit the same to the PDCP device. The NR RLC layer may not include a concatenation function, and the function may be performed by the NR MAC layer, or may be replaced with a multiplexing function of the NR MAC layer.

The non-sequential delivery function (Out-of-sequence delivery) of the NR RLC device is a function of transferring RLC SDUs received from a lower layer directly to a higher layer regardless of the sequence of the RLC SDUs, and may include, when one original RLC SDU is divided into a plurality of RLC SDUs and then received, a function of reassembling and transmitting the RLC PDUs and a function of storing RLC SNs or PDCP SNs of the received RLC PDUs, reordering the RLC PDUs, and recording lost RLC PDUs.

The NR MACs 1d-15 and 1d-30 may be connected to a plurality of NR RLC layer devices configured in one UE and main functions of the NR MAC may include some of the following functions.
Mapping function (Mapping between logical channels and transport channels)
Multiplexing and demultiplexing function (multiplexing/demultiplexing of MAC SDUs)
Scheduling information report function (scheduling information reporting)
HARQ function (error correction through HARQ)
Logical channel priority control function (priority handling between logical channels of one UE)
UE priority control function (priority handling between UEs by means of dynamic scheduling)
MBMS service identification function (MBMS service identification)
Transport format selection function (transport format selection)
Padding function (padding)

The NR PHY layers 1d-20 and 1d-25 perform an operation for channel-coding and modulating higher layer data to generate an OFDM symbol and transmitting the OFDM symbol through a radio channel or demodulating and channel-decoding the OFDM symbol received through the radio channel and transmitting the demodulated and channel-decoded OFDM symbol to the higher layer.

FIG. 1E is a diagram illustrating that a UE in RRC idle mode (RRC_IDLE) or RRC inactive state (RRC_INACTIVE) performs a cell reselection evaluation procedure in a next-generation mobile communication system according to an embodiment of the disclosure.

The cell reselection evaluation procedure may refer to a procedure in which a UE in RRC idle mode (RRC_IDLE) or RRC inactive state (RRC_INACTIVE) determines whether to maintain a current serving cell or reselect the cell as a neighbor cell when the service quality of the serving cell where the UE is currently camping on becomes lower than that of the neighbor cell due to a certain reason or movement.

In the case of handover, the handover operation is determined by the network (AMF or source gNB), while in the case of cell reselection, the UE in RRC idle mode or RRC inactive state can autonomously determine whether to perform the cell reselection operation based on cell measurement values. The cell reselected by the UE may refer to a cell that uses the same NR frequency (NR intra-frequency or serving NR frequency) as the serving cell where the UE is currently camping on, a cell that uses a different NR frequency (NR inter-frequency) from the serving cell, or a cell in a frequency (inter-RAT frequency) using different radio access technology (hereinafter RAT).

With reference to FIG. 1E, in 1e-03, a UE 1e-01 may establish an RRC connection with an NR cell 1e-02 and be in RRC connected mode (RRC_CONNECTED).

In 1e-04, the NR cell 1e-02 may transmit an RRC connection release message (RRCRelease) to release the RRC connection with the UE 1e-01 in RRC connected mode. If the above message includes suspendConfig, in 1e-05 the UE may transition to RRC inactive state (RRC_INACTIVE). If the above message does not include suspendConfig, in 1e-05 the UE may transition to RRC idle mode (RRC_IDLE). The above message may include cellReselectionPriorities for the UE to perform cell reselection. This cellReselectionPriorities may include at least one value among freqPriorityListEUTRA, freqPriorityListNR, and t320. If the t320 value is included in cellReselectionPriorities, the UE can drive a T320 timer with that value. Specifically, configuration information included in the RRCRelease message may be as shown in Table 0 below.

TABLE 0

| | |
|---|---|
| RRCRelease ::= | SEQUENCE { |
| rrc-TransactionIdentifier | RRC-TransactionIdentifier, |
| criticalExtensions | CHOICE { |
| rrcRelease | RRCRelease-IEs, |
| criticalExtensionsFuture | SEQUENCE { } |

}
}

| | |
|---|---|
| RRCRelease-IEs ::= | SEQUENCE { |

| | |
|---|---|
| redirectedCarrierInfo | RedirectedCarrierInfo |

OPTIONAL, -- Need N

| | |
|---|---|
| cellReselectionPriorities | CellReselectionPriorities |

OPTIONAL, -- Need R

| | |
|---|---|
| suspendConfig | SuspendConfig |

OPTIONAL, -- Need R

| | |
|---|---|
| deprioritisationReq | SEQUENCE { |
| deprioritisationType | ENUMERATED {frequency, nr}, |
| deprioritisationTimer | ENUMERATED {min5, min10, min15, min30} |

}
OPTIONAL, -- Need N

| | |
|---|---|
| lateNonCriticalExtension | OCTET STRING |

OPTIONAL,

| | |
|---|---|
| nonCriticalExtension | RRCRelease-v1540-IEs |

OPTIONAL
}

| RRCRelease-v1540-IEs ::= | SEQUENCE { | |
|---|---|---|
| waitTime | RejectWaitTime | OPTIONAL, -- Need N |
| nonCriticalExtension | RRCRelease-v1610-IEs | OPTIONAL |

}

| RRCRelease-v1610-IEs ::= | SEQUENCE { | |
|---|---|---|
| voiceFallbackIndication-r16 | ENUMERATED {true} | OPTIONAL, |

-- Need N

| | | |
|---|---|---|
| measIdleConfig-r16 | SetupRelease {MeasIdleConfigDedicated-r16} | OPTIONAL, |

-- Need M

| | | |
|---|---|---|
| nonCriticalExtension | RRCRelease-v1650-IEs | OPTIONAL |

}

| RRCRelease-v1650-IEs ::= | SEQUENCE { | |
|---|---|---|
| mpsPriorityIndication-r16 | ENUMERATED {true} | OPTIONAL, |

-- Cond Redirection2

| | | |
|---|---|---|
| nonCriticalExtension | SEQUENCE { } | OPTIONAL |

}

| | |
|---|---|
| RedirectedCarrierInfo ::= | CHOICE { |
| nr | CarrierInfoNR, |
| eutra | RedirectedCarrierInfo-EUTRA, |

...
}

| | |
|---|---|
| RedirectedCarrierInfo-EUTRA ::= | SEQUENCE { |
| eutraFrequency | ARFCN-ValueEUTRA, |

| | |
|---|---|
| cnType | ENUMERATED {epc, fiveGC} |

OPTIONAL -- Need N
}

| | |
|---|---|
| CarrierInfoNR ::= | SEQUENCE { |
| carrierFreq | ARFCN-ValueNR, |
| ssbSubcarrierSpacing | SubcarrierSpacing, |

| | |
|---|---|
| smtc | SSB-MTC |

OPTIONAL, -- Need S
...
}

| | |
|---|---|
| SuspendConfig ::= | SEQUENCE { |
| fullI-RNTI | I-RNTI-Value, |
| shortI-RNTI | ShortI-RNTI-Value, |
| ran-PagingCycle | PagingCycle, |

| | |
|---|---|
| ran-NotificationAreaInfo | RAN-NotificationAreaInfo |

OPTIONAL, -- Need M

| | |
|---|---|
| t380 | PeriodicRNAU-TimerValue |

OPTIONAL, -- Need R

| | |
|---|---|
| nextHopChainingCount | NextHopChainingCount, |

```
  ...,
  [[
```

| | |
|---|---|
| sl-ServingCellInfo-r17 | SL-ServingCellInfo-r17 |

OPTIONAL, -- Cond L2RemoteUE

| | |
|---|---|
| sdt-Config-r17 | SetupRelease { SDT-Config-r17 } |

OPTIONAL, -- Need M

| | |
|---|---|
| srs-PosRRC-InactiveConfig-r17 | SRS-PosRRC-InactiveConfig-r17 |

OPTIONAL, -- Need M

| | |
|---|---|
| ran-ExtendedPagingCycle-r17 | ExtendedPagingCycle-r17 |

OPTIONAL -- Need R
]]
}

| | |
|---|---|
| PeriodicRNAU-TimerValue ::= | ENUMERATED { min5, min10, min20, min30, min60, min120, |

min360, min720}

| | |
|---|---|
| CellReselectionPriorities ::= | SEQUENCE { |

| | |
|---|---|
| freqPriorityListEUTRA | FreqPriorityListEUTRA |

OPTIONAL, -- Need M

| | |
|---|---|
| freqPriorityListNR | FreqPriorityListNR |

OPTIONAL, -- Need

| | |
|---|---|
| t320 | ENUMERATED {min5, min10, min20, min30, min60, min120, |

```
min180, spare1} OPTIONAL, -- Need R
  ...,
  [[
```

| | |
|---|---|
| freqPriorityListNRSlicing-r17 | FreqPriorityListNRSlicing-r17 |

OPTIONAL -- Need M
]]
}

| | |
|---|---|
| PagingCycle ::= | ENUMERATED {rf32, rf64, rf128, rf256} |
| ExtendedPagingCycle-r17 ::= | ENUMERATED {rf256, rf512, rf1024, spare1} |
| FreqPriorityListEUTRA ::= | SEQUENCE (SIZE (1..maxFreq)) OF FreqPriorityEUTRA |
| FreqPriorityListNR ::= | SEQUENCE (SIZE (1..maxFreq)) OF FreqPriorityNR |
| FreqPriorityEUTRA ::= | SEQUENCE { |
| carrierFreq | ARFCN-ValueEUTRA, |
| cellReselectionPriority | CellReselectionPriority, |

| | |
|---|---|
| cellReselectionSubPriority | CellReselectionSubPriority |

OPTIONAL -- Need R
}

| | |
|---|---|
| FreqPriorityNR ::= | SEQUENCE { |
| carrierFreq | ARFCN-ValueNR, |
| cellReselectionPriority | CellReselectionPriority, |

| | |
|---|---|
| cellReselectionSubPriority | CellReselectionSubPriority |

OPTIONAL -- Need R
}

| | |
|---|---|
| RAN-NotificationAreaInfo ::= | CHOICE { |
| cellList | PLMN-RAN-AreaCellList, |
| ran-AreaConfigList | PLMN-RAN-AreaConfigList, |

...
}

| | |
|---|---|
| PLMN-RAN-AreaCellList ::= | SEQUENCE (SIZE (1.. maxPLMNIdentities)) OF PLMN-RAN- |

AreaCell

| | |
|---|---|
| PLMN-RAN-AreaCell ::= | SEQUENCE { |

| | |
|---|---|
| plmn-Identity | PLMN-Identity |

OPTIONAL, -- Need S

| | |
|---|---|
| ran-AreaCells | SEQUENCE (SIZE (1..32)) OF CellIdentity |

}

| | |
|---|---|
| PLMN-RAN-AreaConfigList ::= | SEQUENCE (SIZE (1..maxPLMNIdentities)) OF PLMN-RAN- |

AreaConfig

| | |
|---|---|
| PLMN-RAN-AreaConfig ::= | SEQUENCE { |

| | |
|---|---|
| plmn-Identity | PLMN-Identity |

OPTIONAL, -- Need S

| | |
|---|---|
| ran-Area | SEQUENCE (SIZE (1..16)) OF RAN-AreaConfig |

}

| | |
|---|---|
| RAN-AreaConfig ::= | SEQUENCE { |
| trackingAreaCode | TrackingAreaCode, |
| ran-AreaCodeList | SEQUENCE (SIZE (1..32)) OF RAN-AreaCode |

OPTIONAL -- Need R
}

| | |
|---|---|
| SDT-Config-r17 ::= | SEQUENCE { |
| sdt-DRB-List-r17 | SEQUENCE (SIZE (0..maxDRB)) OF DRB-Identity |

OPTIONAL, -- Need M

| | |
|---|---|
| sdt-SRB2-Indication-r17 | ENUMERATED {allowed} |

OPTIONAL, -- Need R

| | |
|---|---|
| sdt-MAC-PHY-CG-Config-r17 | SetupRelease {SDT-CG-Config-r17} |

OPTIONAL, -- Need M

| | |
|---|---|
| sdt-DRB-ContinueROHC-r17 | ENUMERATED { cell, rna } |

OPTIONAL -- Need R
}
SDT-CG-Config-r17 ::= OCTET STRING (CONTAINING SDT-MAC-PHY-CG-Config-r17)

| | |
|---|---|
| SDT-MAC-PHY-CG-Config-r17 ::= | SEQUENCE { |

```
  -- CG-SDT specific configuration
  -- FFS on BSR configuration (e.g. i.e. for the FFS on the logicalChannelSR-DelayTimer)
  -- FFS on delta signalling (We need to clarify how this works, for instance, whether initial
BWP dedicated can be considered as
  -- baseline to enable delta configuration or not etc).
  cg-SDT-Config-LCH-restrictionToAddModList-r17 SEQUENCE (SIZE(1..maxLC-ID)) OF CG-SDT-
Config-LCH-restriction-r17 OPTIONAL, -- Need N
  cg-SDT-Config-LCH-restrictionToReleaseList-r17 SEQUENCE (SIZE(1..maxLC-ID)) OF
LogicalChannelIdentity OPTIONAL, -- Need N
```

| | |
|---|---|
| cg-SDT-Config-Initial-BWP-NUL-r17 | SetupRelease {BWP-Uplink-Dedicated-SDT-r17} |

OPTIONAL, -- Need M

| | |
|---|---|
| cg-SDT-Config-Initial-BWP-SUL-r17 | SetupRelease {BWP-Uplink-Dedicated-SDT-r17} |

OPTIONAL, -- Need M

| | |
|---|---|
| cg-SDT-Config-Initial-BWP-DL-r17 | BWP-Downlink-Dedicated-SDT-r17 |

OPTIONAL, -- Need M

| | |
|---|---|
| cg-SDT-TimeAlignmentTimer-r17 | TimeAlignmentTimer |

OPTIONAL, -- Need M

| | |
|---|---|
| cg-SDT-RSRP-ThresholdSSB-r17 | RSRP-Range |

OPTIONAL, -- Need M

| | |
|---|---|
| cg-SDT-TA-ValiditationConfig-r17 | SetupRelease { CG-SDT-TA-ValiditationConfig-r17 } |

OPTIONAL, -- Need M
...
}
CG-SDT-TA-ValiditationConfig-r17 ::= SEQUENCE {

| | |
|---|---|
| cg-SDT-RSRP-ChangeThreshold-r17 | RSRP-Range |

}

| | |
|---|---|
| BWP-Downlink-Dedicated-SDT-r17 ::= | SEQUENCE { |

| | |
|---|---|
| pdcch-Config-r17 | SetupRelease { PDCCH-Config } |

OPTIONAL, -- Need M

| | |
|---|---|
| pdsch-Config-r17 | SetupRelease { PDSCH-Config } |

OPTIONAL, -- Need M
...

| | |
|---|---|
| }BWP-Uplink-Dedicated-SDT-r17 ::= | SEQUENCE { |

| | |
|---|---|
| pusch-Config-r17 | SetupRelease { PUSCH-Config } |

OPTIONAL, -- Need M

| | |
|---|---|
| configuredGrantConfigToAddModList-r17 | ConfiguredGrantConfigToAddModList- |

r17 OPTIONAL, -- Need N

| | |
|---|---|
| configuredGrantConfigToReleaseList-r17 | ConfiguredGrantConfigToReleaseList- |

r17 OPTIONAL, -- Need N
...
}
ConfiguredGrantConfigToAddModList-r17 ::= SEQUENCE (SIZE (1..maxNrofConfiguredGrantConfig-r16))
OF ConfiguredGrantConfig
ConfiguredGrantConfigToReleaseList-r17 ::= SEQUENCE (SIZE (1..maxNrofConfiguredGrantConfig-
r16)) OF ConfiguredGrantConfigIndex-r16
CG-SDT-Config-LCH-restriction-r17 ::= SEQUENCE {

| | |
|---|---|
| logicalChannelIdentity-r17 | LogicalChannelIdentity, |

| | |
|---|---|
| configuredGrantType1Allowed-r17 | ENUMERATED {true} |

OPTIONAL, -- Need R

| | |
|---|---|
| allowedCG-List-r17 | SEQUENCE (SIZE (0.. maxNrofConfiguredGrant ConfigMAC-1- |

r16)) OF ConfiguredGrantConfigIndexMAC-r16
OPTIONAL -- Need R
}

| | |
|---|---|
| SRS-PosRRC-InactiveConfig-r17 ::= | SEQUENCE { |
| srs-PosConfig-r17 | SRS-PosConfig-r17, |

| | |
|---|---|
| bwp-r17 | BWP |

OPTIONAL, -- Need S

| | |
|---|---|
| srs-TimeAlignmentTimer-r17 | TimeAlignmentTimer |

OPTIONAL, -- Need R

| | |
|---|---|
| inactivePosSRS-RSRP-changeThresh-r17 | RSRP-ChangeThresh-r17 |

OPTIONAL, -- Need R

| | |
|---|---|
| srs-NrofSS-BlocksToAverage-r17 | INTEGER (1..ffsUpperLimit) |

OPTIONAL, -- Need R
-- FFS upper limit

| | |
|---|---|
| inactivePosSRS-AbsThreshSS-BlocksConsolidation-r17 | RSRP-Range |

OPTIONAL -- Need R
}
--Editor's Note: Following temporary constant is introduced only for ASN.1 syntax purposes.
Actual upper limit of the ranges using this constant throughout the specification are FFS.
ffsUpperLimit INTEGER ::= 9999
RSRP-ChangeThresh-r17 ::= ENUMERATED {dB4, dB6, dB8, dB10, dB14, dB18, dB22, dB26, dB30, dB34,
spare6, spare5, spare4, spare3, spare2, spare1}
--Editor's Note: To be updated to align with SDT, to further update SUL/NUL and BWP--

| | |
|---|---|
| SRS-PosConfig-r17 ::= | SEQUENCE { |

```
  srs-PosResourceSetToReleaseList-r17 SEQUENCE (SIZE(1..maxNrofSRS-PosResourceSets-r16)) OF
SRS-PosResourceSetId-r16 OPTIONAL,-- Need N
  srs-PosResourceSetToAddModList-r17 SEQUENCE (SIZE(1..maxNrofSRS-PosResourceSets-r16)) OF
SRS-PosResourceSet-r16 OPTIONAL,-- Need N
  srs-PosResourceToReleaseList-r17 SEQUENCE (SIZE(1..maxNrofSRS-PosResources-r16)) OF
SRS-PosResourceId-r16 OPTIONAL,-- Need N
  srs-PosResourceToAddModList-r17 SEQUENCE (SIZE(1..maxNrofSRS-PosResources-r16)) OF
SRS-PosResource-r16 OPTIONAL -- Need N
}
```

In step 1e-13, the UE in RRC idle mode or RRC inactive state may obtain essential system information from the NR cell 1e-02. In the disclosure, master information block (MIB) and system information block 1 (SIB1) may be referred to as essential system information.

In step 1e-15, the UE in the RRC idle mode or RRC inactive state may perform a cell selection procedure based on the essential system information obtained in step 1e-13. That is, the UE can find an NR suitable cell belonging to selected PLMN or SNPN and camp-on to that cell. The cell where the UE camps-on may be called a serving cell. In the disclosure, based on the 3GPP standard document “38.304: User Equipment (UE) procedures in Idle mode and RRC Inactive state”, a suitable cell can be defined when the conditions in Table 1 below are met.

TABLE 1
suitable cell:
For UE not operating in SNPN Access Mode, a cell is considered as suitable if the following
conditions are fulfilled:
-The cell is part of either the selected PLMN or the registered PLMN or PLMN of the Equivalent
PLMN list, and for that PLMN either:
-The PLMN-ID of that PLMN is broadcast by the cell with no associated CAG-IDs and CAG-only
indication in the UE for that PLMN (TS 23.501 [10]) is absent or false;
-Allowed CAG list in the UE for that PLMN (TS 23.501 [10]) includes a CAG-ID broadcast by the
cell for that PLMN;
-The cell selection criteria are fulfilled, see clause 5.2.3.2.
According to the latest information provided by NAS:
-The cell is not barred, see clause 5.3.1;
-The cell is part of at least one TA that is not part of the list of “Forbidden Tracking Areas
for Roaming” (TS 22.011 [18]), which belongs to a PLMN that fulfils the first bullet above.
For UE operating in SNPN Access Mode, a cell is considered as suitable if the following
conditions are fulfilled:
-The cell is part of either the selected SNPN or the registered SNPN of the UE;
-The cell selection criteria are fulfilled, see clause 5.2.3.2;
According to the latest information provided by NAS:
-The cell is not barred, see clause 5.3.1;
-The cell is part of at least one TA that is not part of the list of “Forbidden Tracking Areas
for Roaming” which belongs to either the selected SNPN or the registered SNPN of the UE.

For reference, the UE may determine that the cell selection criteria are fulfilled if Equation 1 below is satisfied.

$$Srxlev > 0 AND Squal > 0 \qquad [ Equation 1 ]$$

$$where$$

$$Srxlev = {Q}_{rxlevmeas} - ( {Q}_{rxlevmin +} {Q}_{rxlevminoffset} ) - {P}_{compenzation} - {Qoffset}_{temp} ,$$

$$Squal = {Q}_{qualmeas} - ( {Q}_{qualmin} + {Q}_{qualminoffset} ) - {Qoffset}_{temp} .$$

For definitions of parameters used here, refer to the 3GPP standard document “38.304: User Equipment (UE) procedures in Idle mode and RRC Inactive state”.

In step 1e-20, the UE in RRC idle mode or RRC inactive state may obtain system information (e.g., SIB2, SIB3, SIB4, SIB5) including cell reselection information from the serving cell 1e-02 to perform a cell reselection evaluation procedure. SIB2 may include information/parameters commonly applied for the UE to reselect NR intra-frequency, NR inter-frequency, and inter-RAT frequency cells, and NR intra-frequency cell reselection information excluding information related to NR intra-frequency neighbor cells. In an example, SIB2 may include one cell reselection priority configuration information for a serving NR frequency (the frequency to which the currently camp-on cell belongs). The cell reselection priority configuration information may mean cellReselectionPriority and cellReselectionSubPriority. Specifically, cellReselectionPriority may include an integer value (e.g., any integer value from among 0 to 7), and cellReselectionSubPriority may include a decimal value (e.g., any decimal value from among 0.2, 0.4, 0.6, and 0.8). If both cellReselectionPriority and cellReselectionSubPriority are signaled, the UE may add the two values to derive a cell reselection priority value. For reference, a larger cell reselection priority value denotes a higher priority. The serving cell according to the disclosure is characterized by always (mandatorily) broadcasting cellReselectionPriority mapped to the serving NR frequency through SIB2, and is characterized by always broadcasting the cell reselection priority configuration information for the serving NR frequency because cellReselectionSubPriority is optionally broadcast. Specifically, the cell reselection configuration information broadcasted in SIB2 may be as shown in Table 2 below.

TABLE 2

| SIB2 ::= | SEQUENCE { | |
|---|---|---|
| cellReselectionInfoCommon | SEQUENCE { | |
| nrofSS-BlocksToAverage | | INTEGER (2..maxNrofSS-BlocksToAverage) |

OPTIONAL, -- Need S

| | |
|---|---|
| absThreshSS-BlocksConsolidation | ThresholdNR |

OPTIONAL, -- Need S

| | |
|---|---|
| rangeToBestCell | RangeToBestCell |

OPTIONAL, -- Need R

| | |
|---|---|
| q-Hyst | ENUMERATED { |
| | dB0, dB1, dB2, dB3, dB4, dB5, dB6, dB8, dB10, |
| | dB12, dB14, dB16, dB18, dB20, dB22, dB24}, |
| speedStateReselectionPars | SEQUENCE { |
| mobilityStateParameters | MobilityStateParameters, |
| q-HystSF | SEQUENCE { |
| sf-Medium | ENUMERATED {dB−6, dB−4, dB−2, dB0}, |
| sf-High | ENUMERATED {dB−6, dB−4, dB−2, dB0} |

```
      }
    }
OPTIONAL, -- Need R
  ...
  },
```

| | |
|---|---|
| cellReselectionServingfreqInfo | SEQUENCE { |

| | |
|---|---|
| s-NonIntraSearchP | ReselectionThreshold |

OPTIONAL, -- Need S

| | |
|---|---|
| s-NonIntraSearchQ | ReselectionThresholdQ |

OPTIONAL, -- Need S

| | |
|---|---|
| threshServingLowP | ReselectionThreshold, |

| | |
|---|---|
| threshServingLowQ | ReselectionThresholdQ |

OPTIONAL, -- Need R

| | |
|---|---|
| cellReselectionPriority | CellReselectionPriority, |

| | |
|---|---|
| cellReselectionSubPriority | CellReselectionSubPriority |

```
OPTIONAL, -- Need R
    ...
  },
```

| | |
|---|---|
| intraFreqCellReselectionInfo | SEQUENCE { |
| q-RxLevMin | Q-RxLevMin, |

| | |
|---|---|
| q-RxLevMinSUL | Q-RxLevMin |

OPTIONAL, -- Need R

| | |
|---|---|
| q-QualMin | Q-QualMin |

OPTIONAL, -- Need S

| | |
|---|---|
| s-IntraSearchP | ReselectionThreshold, |

| | |
|---|---|
| s-IntraSearchQ | ReselectionThresholdQ |

OPTIONAL, -- Need S

| | |
|---|---|
| t-ReselectionNR | T-Reselection, |

| | |
|---|---|
| frequencyBandList | MultiFrequencyBandListNR-SIB |

OPTIONAL, -- Need S

| | |
|---|---|
| frequencyBandListSUL | MultiFrequencyBandListNR-SIB |

OPTIONAL, -- Need R

| | |
|---|---|
| p-Max | P-Max |

OPTIONAL, -- Need S

| | |
|---|---|
| smtc | SSB-MTC |

OPTIONAL, -- Need S

| | |
|---|---|
| ss-RSSI-Measurement | SS-RSSI-Measurement |

OPTIONAL, -- Need R

| | |
|---|---|
| ssb-ToMeasure | SSB-ToMeasure |

OPTIONAL, -- Need S

| | |
|---|---|
| deriveSSB-IndexFromCell | BOOLEAN, |

```
    ...,
    [[
```

| | |
|---|---|
| t-ReselectionNR-SF | SpeedStateScaleFactors |

```
OPTIONAL -- Need N
    ]],
    [[
```

| | |
|---|---|
| smtc2-LP-r16 | SSB-MTC2-LP-r16 |

OPTIONAL, -- Need R

| | |
|---|---|
| ssb-PositionQCL-Common-r16 | SSB-PositionQCL-Relation-r16 |

```
OPTIONAL -- Cond SharedSpectrum
    ]]
  },
  ...,
  [[
```

| | |
|---|---|
| relaxedMeasurement-r16 | SEQUENCE { |
| lowMobilityEvaluation-r16 | SEQUENCE { |
| s-SearchDeltaP-r16 | ENUMERATED { |
| | dB3, dB6, dB9, dB12, dB15, |
| | spare3, spare2, spare1}, |
| t-SearchDeltaP-r16 | ENUMERATED { |
| | s5, s10, s20, s30, s60, s120, s180, |
| | s240, s300, spare7, spare6, spare5, |
| | spare4, spare3, spare2, spare1} |

}
OPTIONAL, -- Need R

| | |
|---|---|
| cellEdgeEvaluation-r16 | SEQUENCE { |
| s-SearchThresholdP-r16 | ReselectionThreshold, |

| | |
|---|---|
| s-SearchThresholdQ-r16 | ReselectionThresholdQ |

OPTIONAL -- Need R
}
OPTIONAL, -- Need R

| | |
|---|---|
| combineRelaxedMeasCondition-r16 | ENUMERATED {true} |

OPTIONAL, -- Need R

| | |
|---|---|
| highPriorityMeasRelax-r16 | ENUMERATED {true} |

```
OPTIONAL -- Need R
  }
OPTIONAL -- Need R
    ]]
}
RangeToBestCell ::= Q-OffsetRange
```

SIB3 may include neighbor cell information/parameters for the UE in RRC idle mode or RRC inactive state to reselect the NR intra-frequency cell. For example, in SIB3, an NR intra-frequency cell list (intraFreqNeighCellList) for reselecting the NR intra-frequency cell, or a cell list (intraFreqBlackCellList) for which NR intra-frequency cell reselection is not allowed may be broadcast. Specifically, information in Table 3 below may be broadcasted in SIB3.

TABLE 3

| | |
|---|---|
| SIB3 ::= | SEQUENCE { |

| | |
|---|---|
| intraFreqNeighCellList | IntraFreqNeighCellList |

OPTIONAL, -- Need R

| | |
|---|---|
| intraFreqBlackCellList | IntraFreqBlackCellList |

OPTIONAL, -- Need R

| | |
|---|---|
| lateNonCriticalExtension | OCTET STRING |

```
OPTIONAL,
  ...,
  [[
```

| | |
|---|---|
| intraFreqNeighCellList-v1610 | IntraFreqNeighCellList-v1610 |

OPTIONAL, -- Need R

| | |
|---|---|
| intraFreqWhiteCellList-r16 | IntraFreqWhiteCellList-r16 |

OPTIONAL, -- Cond SharedSpectrum2

| | |
|---|---|
| intraFreqCAG-CellList-r16 | SEQUENCE (SIZE (1..maxPLMN)) OF IntraFreqCAG- |

CellListPerPLMN-r16 OPTIONAL -- Need R
]]
}

| | |
|---|---|
| IntraFreqNeighCellList ::= | SEQUENCE (SIZE (1..maxCellIntra)) OF IntraFreqNeighCellInfo |
| IntraFreqNeighCellList-v1610::= | SEQUENCE (SIZE (1..maxCellIntra)) OF |

IntraFreqNeighCellInfo-v1610

| | |
|---|---|
| IntraFreqNeighCellInfo ::= | SEQUENCE { |
| physCellId | PhysCellId, |
| q-OffsetCell | Q-OffsetRange, |

| | |
|---|---|
| q-RxLevMinOffsetCell | INTEGER (1..8) |

OPTIONAL, -- Need R

| | |
|---|---|
| q-RxLevMinOffsetCellSUL | INTEGER (1..8) |

OPTIONAL, -- Need R

| | |
|---|---|
| q-QualMinOffsetCell | INTEGER (1..8) |

OPTIONAL, -- Need R
...
}

| | |
|---|---|
| IntraFreqNeighCellInfo-v1610 ::= | SEQUENCE { |

| | |
|---|---|
| ssb-PositionQCL-r16 | SSB-PositionQCL-Relation-r16 |

OPTIONAL -- Cond SharedSpectrum2
}

| | |
|---|---|
| IntraFreqBlackCellList ::= | SEQUENCE (SIZE (1..maxCellBlack)) OF PCI-Range |
| IntraFreqWhiteCellList-r16 ::= | SEQUENCE (SIZE (1..maxCellWhite)) OF PCI-Range |

IntraFreqCAG-CellListPerPLMN-r16 ::= SEQUENCE {

| | |
|---|---|
| plmn-IdentityIndex-r16 | INTEGER (1..maxPLMN), |
| cag-CellList-r16 | SEQUENCE (SIZE (1..maxCAG-Cell-r16)) OF PCI-Range |

}

SIB4 may include information/parameters for the UE in RRC idle mode or RRC inactive state to reselect the NR inter-frequency cell. For example, one or multiple NR inter-frequencies may be broadcasted in SIB4, and one cell reselection priority configuration information per NR inter-frequency may be broadcast. The cell reselection priority configuration information per NR inter-frequency refers to the above-mentioned contents (e.g., cellReselectionPriority and/or cellReselectionSubPriority mapped to each NR inter-frequency), but only one cell reselection priority configuration information per inter-frequency is optionally broadcast. Specifically, information in Table 4 below may be broadcasted in SIB4.

TABLE 4

| SIB4 ::= | SEQUENCE { | |
|---|---|---|
| interFreqCarrierFreqList | InterFreqCarrierFreqList, | |
| lateNonCriticalExtension | OCTET STRING | OPTIONAL, |

```
  ...,
  [[
```

| | | |
|---|---|---|
| interFreqCarrierFreqList-v1610 | InterFreqCarrierFreqList-v1610 | OPTIONAL |

-- Need R
]]
}

| | |
|---|---|
| InterFreqCarrierFreqList ::= | SEQUENCE (SIZE (1..maxFreq)) OF InterFreqCarrierFreqInfo |

InterFreqCarrierFreqList-v1610 ::= SEQUENCE (SIZE (1..maxFreq)) OF InterFreqCarrierFreqInfo-
v1610

| | |
|---|---|
| InterFreqCarrierFreqInfo ::= | SEQUENCE { |
| dl-CarrierFreq | ARFCN-ValueNR, |

| | |
|---|---|
| frequencyBandList | MultiFrequencyBandListNR-SIB |

OPTIONAL, -- Cond Mandatory

| | |
|---|---|
| frequencyBandListSUL | MultiFrequencyBandListNR-SIB |

OPTIONAL, -- Need R

| | |
|---|---|
| nrofSS-BlocksToAverage | INTEGER (2..maxNrofSS-BlocksToAverage) |

OPTIONAL, -- Need S

| | |
|---|---|
| absThreshSS-BlocksConsolidation | ThresholdNR |

OPTIONAL, -- Need S

| | |
|---|---|
| smtc | SSB-MTC |

OPTIONAL, -- Need S

| | |
|---|---|
| ssbSubcarrierSpacing | SubcarrierSpacing, |

| | |
|---|---|
| ssb-ToMeasure | SSB-ToMeasure |

OPTIONAL, -- Need S

| | |
|---|---|
| deriveSSB-IndexFromCell | BOOLEAN, |

| | |
|---|---|
| ss-RSSI-Measurement | SS-RSSI-Measurement |

OPTIONAL,

| | |
|---|---|
| q-RxLevMin | Q-RxLevMin, |

| | |
|---|---|
| q-RxLevMinSUL | Q-RxLevMin |

OPTIONAL, -- Need R

| | |
|---|---|
| q-QualMin | Q-QualMin |

OPTIONAL, -- Need S

| | |
|---|---|
| p-Max | P-Max |

OPTIONAL, -- Need S

| | |
|---|---|
| t-ReselectionNR | T-Reselection, |

| | |
|---|---|
| t-ReselectionNR-SF | SpeedStateScaleFactors |

OPTIONAL, -- Need S

| | |
|---|---|
| threshX-HighP | ReselectionThreshold, |
| threshX-LowP | ReselectionThreshold, |
| threshX-Q | SEQUENCE { |
| threshX-HighQ | ReselectionThresholdQ, |
| threshX-LowQ | ReselectionThresholdQ |

}
OPTIONAL, -- Cond RSRQ

| | |
|---|---|
| cellReselectionPriority | CellReselectionPriority |

OPTIONAL, -- Need R

| | |
|---|---|
| cellReselectionSubPriority | CellReselectionSubPriority |

OPTIONAL, -- Need R

| | |
|---|---|
| q-OffsetFreq | Q-OffsetRange |

DEFAULT dB0,

| | |
|---|---|
| interFreqNeighCellList | InterFreqNeighCellList |

OPTIONAL, -- Need R

| | |
|---|---|
| interFreqBlackCellList | InterFreqBlackCellList |

OPTIONAL, -- Need R
...
}

| | |
|---|---|
| InterFreqCarrierFreqInfo-v1610 ::= | SEQUENCE { |

| | |
|---|---|
| interFreqNeighCellList-v1610 | InterFreqNeighCellList-v1610 |

OPTIONAL, -- Need R

| | |
|---|---|
| smtc2-LP-r16 | SSB-MTC2-LP-r16 |

OPTIONAL, -- Need R

| | |
|---|---|
| interFreqWhiteCellList-r16 | InterFreqWhiteCellList-r16 |

OPTIONAL, -- Cond SharedSpectrum2

| | |
|---|---|
| ssb-PositionQCL-Common-r16 | SSB-PositionQCL-Relation-r16 |

OPTIONAL, -- Cond SharedSpectrum

| | |
|---|---|
| interFreqCAG-CellList-r16 | SEQUENCE (SIZE (1..maxPLMN)) OF InterFreqCAG- |

CellListPerPLMN-r16 OPTIONAL -- Need R
}

| | |
|---|---|
| InterFreqNeighCellList ::= | SEQUENCE (SIZE (1..maxCellInter)) OF InterFreqNeighCellInfo |
| InterFreqNeighCellList-v1610 ::= | SEQUENCE (SIZE (1..maxCellInter)) OF |

InterFreqNeighCellInfo-v1610

| | |
|---|---|
| InterFreqNeighCellList ::= | SEQUENCE (SIZE (1..maxCellInter)) OF InterFreqNeighCellInfo |
| InterFreqNeighCellList-v1610 ::= | SEQUENCE (SIZE (1..maxCellInter)) OF |

InterFreqNeighCellInfo-v1610

| | |
|---|---|
| InterFreqNeighCellInfo ::= | SEQUENCE { |
| physCellId | PhysCellId, |
| q-OffsetCell | Q-OffsetRange, |

| | |
|---|---|
| q-RxLevMinOffsetCell | INTEGER (1..8) |

OPTIONAL, -- Need R

| | |
|---|---|
| q-RxLevMinOffsetCellSUL | INTEGER (1..8) |

OPTIONAL, -- Need R

| | |
|---|---|
| q-QualMinOffsetCell | INTEGER (1..8) |

OPTIONAL, -- Need R
...
}

| | |
|---|---|
| InterFreqNeighCellInfo-v1610 ::= | SEQUENCE { |

| | |
|---|---|
| ssb-PositionQCL-r16 | SSB-PositionQCL-Relation-r16 |

OPTIONAL -- Cond SharedSpectrum2
}

| | |
|---|---|
| InterFreqBlackCellList ::= | SEQUENCE (SIZE (1..maxCellBlack)) OF PCI-Range |
| InterFreqWhiteCellList-r16 ::= | SEQUENCE (SIZE (1..maxCellWhite)) OF PCI-Range |

InterFreqCAG-CellListPerPLMN-r16 ::= SEQUENCE {

| | |
|---|---|
| plmn-IdentityIndex-r16 | INTEGER (1..maxPLMN), |
| cag-CellList-r16 | SEQUENCE (SIZE (1..maxCAG-Cell-r16)) OF PCI-Range |

}

SIB5 may include information/parameters for the UE in RRC idle mode or RRC inactive state to reselect the inter-RAT frequency cell. For example, one or more EUTRA frequencies may be broadcasted in SIB5, and one cell reselection priority configuration information per EUTRA frequency may be broadcast. The cell reselection priority configuration information per EUTRA frequency refers to the above-described contents (e.g., cellReselectionPriority and/or cellReselectionSubPriority mapped to each EUTRA frequency), but only one cell reselection priority configuration information per EUTRA frequency is optionally broadcast. Specifically, information in Table 5 below may be broadcasted in SIB5.

TABLE 5

| SIB5 ::= | SEQUENCE { | |
|---|---|---|
| carrierFreqListEUTRA | CarrierFreqListEUTRA | OPTIONAL, |

-- Need R

| t-ReselectionEUTRA | T-Reselection, | |
|---|---|---|
| t-ReselectionEUTRA-SF | SpeedStateScaleFactors | OPTIONAL, |

-- Need S

| | | |
|---|---|---|
| lateNonCriticalExtension | OCTET STRING | OPTIONAL, |

```
  ...,
  [[
```

| | | |
|---|---|---|
| carrierFreqListEUTRA-v1610 | CarrierFreqListEUTRA-v1610 | OPTIONAL |

-- Need R
]]
}

| | |
|---|---|
| CarrierFreqListEUTRA ::= | SEQUENCE (SIZE (1..maxEUTRA-Carrier)) OF CarrierFreqEUTRA |
| CarrierFreqListEUTRA-v1610 ::= | SEQUENCE (SIZE (1..maxEUTRA-Carrier)) OF CarrierFreqEUTRA- |

v1610

| CarrierFreqEUTRA ::= | SEQUENCE { | |
|---|---|---|
| carrierFreq | ARFCN-ValueEUTRA, | |
| eutra-multiBandInfoList | EUTRA-MultiBandInfoList | OPTIONAL, |

-- Need R

| | | |
|---|---|---|
| eutra-FreqNeighCellList | EUTRA-FreqNeighCellList | OPTIONAL, |

-- Need R

| | | |
|---|---|---|
| eutra-BlackCellList | EUTRA-FreqBlackCellList | OPTIONAL, |

-- Need R

| allowedMeasBandwidth | EUTRA-AllowedMeasBandwidth, | |
|---|---|---|
| presenceAntennaPort1 | EUTRA-PresenceAntennaPort1, | |
| cellReselectionPriority | CellReselectionPriority | OPTIONAL, |

-- Need R

| | | |
|---|---|---|
| cellReselectionSubPriority | CellReselectionSubPriority | OPTIONAL, |

-- Need R

| | |
|---|---|
| threshX-High | ReselectionThreshold, |
| threshX-Low | ReselectionThreshold, |
| q-RxLevMin | INTEGER (−70..−22), |
| q-QualMin | INTEGER (−34..−3), |
| p-MaxEUTRA | INTEGER (−30..33), |
| threshX-Q | SEQUENCE { |
| threshX-HighQ | ReselectionThresholdQ, |
| threshX-LowQ | ReselectionThresholdQ |

| | |
|---|---|
| } | OPTIONAL |

-- Cond RSRQ
}
CarrierFreqEUTRA-v1610 ::= SEQUENCE {

| | | |
|---|---|---|
| highSpeedEUTRACarrier-r16 | ENUMERATED {true} | OPTIONAL |

-- Need R
}

| | |
|---|---|
| EUTRA-FreqBlackCellList ::= | SEQUENCE (SIZE (1..maxEUTRA-CellBlack)) OF EUTRA- |

PhysCellIdRange

| | |
|---|---|
| EUTRA-FreqNeighCellList ::= | SEQUENCE (SIZE (1..maxCelIEUTRA)) OF EUTRA- |

FreqNeighCellInfo

| EUTRA-FreqNeighCellInfo ::= | SEQUENCE { | |
|---|---|---|
| physCellId | EUTRA-PhysCellId, | |
| dummy | EUTRA-Q-OffsetRange, | |
| q-RxLevMinOffsetCell | INTEGER (1..8) | OPTIONAL, |

-- Need R

| | | |
|---|---|---|
| q-QualMinOffsetCell | INTEGER (1..8) | OPTIONAL |

-- Need R
}

The UE in RRC idle mode or RRC inactive state may perform the cell reselection evaluation procedure (process). The cell reselection evaluation procedure may refer to a series of processes for determining reselection priorities (reselection priorities handling), performing frequency measurement by applying measurement rules for cell reselection, and reselecting the cell by evaluating the cell reselection criteria.

In step 1e-25, the UE in RRC idle mode or RRC inactive state may determine the reselection priorities based on the RRC connection release message received in step 1e-04 or the system information received in step 1e-20. If the RRC connection release message received in step 1e-04 includes cellReselectionPriorities, and if there is no t320 timer value in cellReselectionPriorities or if the t320 timer value is configured and the T320 timer is running, the UE may determine the reselection priorities according to the RRC connection release message. That is, in the case of being able to apply celllReselectionPriorities included in the RRC connection release message, the UE can determine the reselection priorities according to the RRC connection release message. If cellReselectionPriorities is not included in the RRC connection release message or cellReselectionPriorities is released, the UE may determine the reselection priorities based on the system information received in step 1e-20. Based on the cell reselection priority value mapped to the NR frequency to which the currently camp-on serving cell belongs, the UE according to the disclosure can determine whether the cell reselection priority for each NR inter-frequency or inter-RAT frequency is equal to, higher than, or lower than that of the NR frequency to which the serving cell belongs. For example, if in the system information obtained in step 1e-20 the cell reselection priority value mapped to the NR frequency to which the currently camp-on serving cell belongs is 3, the cell reselection priority value of inter NR frequency 1 is 2, the cell reselection priority value of inter NR frequency 2 is 3, the cell reselection priority value of inter NR frequency 3 is 4, and the cell reselection priority value of EUTRA frequency 1 is 2, then the UE may determine the cell reselection priorities of inter NR frequency 1 and EUTRA frequency 1 as lower cell reselection priorities, determine the cell reselection priority of inter NR frequency 2 as an equal reselection priority, and determine the cell reselection priority of inter NR frequency 3 as a higher cell reselection priority.

In step 1e-30, the UE in RRC idle mode or RRC inactive state may perform frequency measurement for cell reselection. At this time, in order to minimize battery consumption, the UE may perform frequency measurement using the following measurement rules according to the cell reselection priorities determined in step 1e-25.
If condition 1 below is satisfied, the UE may not perform NR intra-frequency measurement. Otherwise (e.g., if condition 1 below is not satisfied), the UE performs NR intra-frequency measurement.
   Condition 1: The reception level (Srxlev) of the serving cell is greater than the SIntraSearchP threshold and the reception quality (Squal) of the serving cell is greater than the SIntraSearchQ threshold (Serving cell fulfils Srxlev>SIntraSearchP and Squal>SIntraSearchQ).
For NR inter-frequency or inter-RAT frequency with a higher reselection priority than the NR frequency of the current serving cell, the UE may perform measurements according to the 3GPP TS 38.133 standard.
For NR inter-frequency with a reselection priority lower than or equal to the NR frequency of the current serving cell and for inter-RAT frequency with a reselection priority lower than the NR frequency of the current serving cell, if condition 2 below is satisfied, the UE may not perform measurements. Otherwise (e.g., if condition 2 below is not satisfied), the UE measures cells in NR inter-frequency with a reselection priority lower than or equal to the NR frequency, or measures cells in inter-RAT frequency with a reselection priority lower than the NR frequency.
   Condition 2: The reception level (Srxlev) of the serving cell is greater than the SnonIntraSearchP threshold and the reception quality (Squal) of the serving cell is greater than the SnonIntraSearchQ threshold (Serving cell fulfils Srxlev>SnonIntraSearchP and Squal>SnonIntraSearchQ).

For reference, the above-mentioned thresholds (SintraSearchP, SintraSearchQ, SnonIntraSearchP, SnonintraSearchQ) may be broadcasted in the system information obtained in step 1e-20.

In step 1e-35, the UE in RRC idle mode or RRC inactive state may decide to reselect a cell that satisfies the cell reselection criteria based on the measurement value performed in step 1e-30. Depending on the cell reselection priorities, different cell reselection criteria may be applied. Cell reselection to a higher priority RAT/frequency shall take precede over a lower priority RAT/frequency if multiple cells of different priorities fulfil the cell reselection criteria. Specifically, the UE's operation with respect to the reselection criteria of the inter-frequency/inter-RAT cell with a higher priority than the frequency of the current serving cell is as follows.

### First Operation:

If SIB2 is broadcasted with a threshold for threshServingLowQ and one second has passed since the UE camped on the current serving cell, and if the signal quality (Squal) of the inter-frequency/inter-RAT cell is greater than the threshold ThreshX,HighQ during the time interval TreselectionRAT, the UE performs reselection to the corresponding inter-frequency/inter-RAT cell.

### Second Operation:

If the UE fails to perform the first operation, it performs the second operation.
If one second has passed since the UE camped on the current serving cell and the reception level (Srxlev) of the inter-frequency/inter-RAT cell is greater than the threshold ThreshX,HighP during the time interval TreselectionRAT, the UE performs reselection to the corresponding inter-frequency/inter-RAT cell.

When performing the first or second operation, the UE uses the values of signal quality (Squal), reception level (Srxlev), thresholds (ThreshX,HighQ, ThreshX,HighP), and TreselectionRAT for the inter-frequency cell based on information included in SIB4 broadcasted from the serving cell, and uses the values of signal quality (Squal), reception level (Srxlev), thresholds (ThreshX,HighQ, ThreshX,HighP), and TreselectionRAT for the inter-RAT cell based on information included in SIB5 broadcasted from the serving cell. For example, SIB4 includes a Qqualmin value or a Qrxlevmin value, and based on this, the signal quality (Squal) or reception level (Srxlev) of the inter-frequency cell is derived. If there are a plurality of cells in the NR frequency that satisfy the high cell reselection priority, the UE may reselect the highest ranked cell among cells that satisfy the reselection criteria of the intra-frequency/inter-frequency cell having the same priority as the frequency of the current serving cell as described below.

Additionally, the UE's operation regarding the reselection criteria of the intra-frequency/inter-frequency cell that has the same priority as the frequency of the current serving cell is as follows.

### Third Operation:

If the signal quality (Squal) and reception level (Srxlev) of the intra-frequency/inter-frequency cell are greater than 0, the UE derives the rank for each cell based on the measurement value (RSRP). That is, the UE shall perform ranking of all cells that fulfills the cell selection criterion S. The ranks of the serving cell and the neighbor cell are each calculated using Equation 2 below.

$${R}_{s} = {Q}_{meas , s} + {Q}_{hyst} - {Qoffset}_{temp} \qquad [ Equation 2 ]$$

$${R}_{n} = {Q}_{meas , n} - Qoffset - {Qoffset}_{temp}$$

Here, Qmeas,s is the RSRP measurement value of the serving cell, Qmeas,n is the RSRP measurement value of the neighbor cell, Qhyst is the hysteresis value of the serving cell, and Qoffset is the offset between the serving cell and the neighbor cell. SIB2 includes the Qhyst value, which is commonly used for reselection of the intra-frequency/inter-frequency cells. In the case of intra-frequency cell reselection, Qoffset is signaled for each cell, applied for only the indicated cell, and included in SIB3. In the case of inter-frequency cell reselection, Qoffset is signaled for each cell, applied for only the indicated cell, and included in SIB4. If any neighbor cell has the rank obtained from Equation 2 above greater than the rank of the serving cell (Rn>Rs), it is reselected as the optimal cell among neighbor cells.
Here, Qoffset-temp—is an offset temporarily applied to the cell and may refer to connEstFailOffset included in ConnEstFailureControld broadcasted in SIB1. It may be applied when RRC connection fails (e.g., when the T300 timer expires).

In addition, the UE's operation regarding the reselection criteria of the inter-frequency/inter-RAT cell with a lower priority than the frequency of the current serving cell is as follows.

### Fourth Operation:

If SIB2 is broadcasted with a threshold for threshServingLowQ and one second has passed since the UE camped on the current serving cell, and if the signal quality (Sqaul) of the current serving cell is less than the threshold ThreshServing,LowQ and the signal quality (Squal) of the inter-frequency/inter-RAT cell is greater than the threshold ThreshX,LowQ during the time interval TreselectionRAT, the UE performs reselection to the corresponding inter-frequency/inter-RAT cell.

### Fifth Operation:

If the UE fails to perform the fourth operation, it performs the fifth operation.
If one second has passed since the UE camped on the current serving cell, the reception level (Srxlev) of the current serving cell is less than the threshold ThreshServing,LowP, and the reception level (Srxlev) of the inter-frequency/inter-RAT cell is greater than the threshold ThreshX,LowP during the time interval TreselectionRAT, the UE performs reselection to the corresponding inter-frequency/inter-RAT cell.

Here, the UE's fourth or fifth operation for the inter-frequency cell is performed based on thresholds (ThreshServing,LowQ, ThreshServing,LowP) included in SIB2 broadcasted from the serving cell and based on signal quality (Squal), reception level (Srxlev), thresholds (ThreshX,LowQ, ThreshX,LowP), and TreselectionRAT for the inter-frequency cell included in SIB4 broadcasted from the serving cell, and the UE's fourth or fifth operation for the inter-RAT cell is performed based on thresholds (ThreshServing,LowQ, ThreshServing,LowP) included in SIB2 broadcasted from the serving cell and based on signal quality (Squal), reception level (Srxlev), thresholds (ThreshX,LowQ, ThreshX,LowP), and TreselectionRAT for the inter-RAT cell included in SIB5 broadcasted from the serving cell. For example, SIB4 includes a Qqualmin value or a Qrxlevmin value, and based on this, the signal quality (Squal) or reception level (Srxlev) of the inter-frequency cell is derived. If there are a plurality of cells in the NR frequency that satisfy the high cell reselection priority, the UE may reselect the highest ranked cell among cells that satisfy the reselection criteria of the intra-frequency/inter-frequency cell having the same priority as the frequency of the current serving cell as described below.

In step 1e-40, the UE in RRC idle mode or RRC inactive state receives system information (e.g., MIB or SIB1) broadcasted from a candidate target cell before finally reselecting the candidate target cell, and determines, based on the received system information, whether the reception level (Srxlev) and reception quality (Squal) of the candidate target cell meet the cell selection criterion called S-criterion (Equation 1) (Srxlev>0 AND Squal>0). If Equation 1 is satisfied and the candidate target cell is suitable, the UE may reselect the candidate target cell.

FIG. 1G is a flowchart illustrating a process in which a UE reports a mobility state to an NR base station in a typical NR mobile communication system according to an embodiment of the disclosure.

In the typical NR system according to this embodiment, the UE determines the mobility state in RRC idle mode or RRC inactive mode and reports it to the NR base station.

With reference to FIG. 1F, the UE 1g-01 may be in RRC idle mode (RRC_IDLE) or RRC inactive mode (RRC_INACTIVE).

In step 1g-10, the UE 1g-01 in RRC idle mode or RRC inactive mode may receive or obtain system information from the base station 1g-02. The system information may include parameters for the UE to perform a cell selection or cell reselection process. This may follow the above-described embodiment. Additionally, the base station 1g-02 may broadcast the system information including parameters (speedStateReselectionPars) for determining the mobility state of the UE.
t-Evaluation: The duration of evaluating criteria to enter mobility states. For example, one of values such as 30 seconds, 60 seconds, 120 seconds, 180 seconds, or 240 seconds may be signaled.
   The t-Evaluation may refer to T_{CRmax}, and this specifies the duration for evaluating allowed amount of cell reselection(s).
t-HystNormal: The additional duration for evaluating criteria to enter normal mobility state. For example, one of values such as 30 seconds, 60 seconds, 120 seconds, 180 seconds, or 240 seconds may be signaled.
   The t-HystNormal may refer to T_{CRmaxHyst}, and this specifies the additional time period before the UE can enter Normal-mobility state.
n-CellChangeMedium: The number of cell changes to enter medium mobility state. For example, one of integer values from 1 to 16 may be signaled.
   The n-CellChangeMedium may refer to N_{CR_M}, and this specifies the maximum number of cell reselections to enter Medium-mobility state.
n-CellChangeHigh: The number of cell changes to enter high mobility state. For example, one of integer values from 1 to 16 may be signaled, and a value greater than n-CellChangeMedium may be signaled.
   The n-CellChangeHigh may refer ton N_{CR_H}, and this specifies the maximum number of cell reselections to enter High-mobility state.
q-HystSF: Speed-based ScalingFactor parameter
   sf-Medium: An additional hysteresis parameter value used in medium mobility state. For example, one value from among −6 dB, −4 dB, −2 dB, and 0 dB may be signaled.
   sf-High: An additional hysteresis parameter value used in high mobility state. For example, one value from among −6 dB, −4 dB, −2 dB, and 0 dB may be signaled.
t-Reselection-SF (per NR frequency): SpeedStateScaleFactors parameter
   sf-Medium: An additional mobility control related parameter value used in medium mobility state. For example, one value from among 0.25, 0.5, 0.75, and 1 may be signaled.
   sf-High: An additional mobility control related parameter value used in high mobility state. For example, one value from among 0.25, 0.5, 0.75, and 1 may be signaled.
t-ReselectionEUTRA-SF (per EUTRA frequency or common for all EUTRA frequencies): SpeedStateScaleFactors parameter
   sf-Medium: An additional mobility control related parameter value used in medium mobility state. For example, one value from among 0.25, 0.5, 0.75, and 1 may be signaled.
   sf-High: An additional mobility control related parameter value used in high mobility state. For example, one value from among 0.25, 0.5, 0.75, and 1 may be signaled.

In step 1g-15, the UE 1g-01 in RRC idle mode or RRC inactive mode may perform a cell selection or cell reselection process. This may follow the above-described embodiment.

In step 1g-20, the UE 1g-01 in RRC idle mode or RRC inactive mode may determine the mobility state. The UE may determine the mobility state based on the following predetermined criteria.
Medium-mobility state criteria
   If the number of cell reselections during time period T_{CRmax} is greater than or equal to N_{CR_M} but less than or equal to N_{CR_H}
High-mobility state criteria
   If the number of cell reselections during time period T_{CRmax} is greater than N_{CR_H}
Normal-mobility state criteria
   If the criteria for either Medium- or High-mobility state is not detected during time period T_{CRmaxHsyt} or if the number of cell reselections during time period T_{CRmax} is less than N_{CR_M}

The UE may perform a cell reselection process by applying a scaling rule according to the determined mobility state. Specifically,
If neither Medium- nor High-mobility state is detected,
   No scaling is applied.
If high-mobility state is detected,
   Add the sf-High of “Speed dependent ScalingFactor for Qhyst” to Qhyst if broadcasted in system information.
   For NR cells, multiply TreselectionNR by the sf-High of “Speed dependent ScalingFactor for TreselectionNR” if broadcasted in system information.
   For EUTRA cells, multiply TreselectionEUTRA by the sf-High of “Speed dependent ScalingFactor for TreselectionEUTRA” if broadcasted in system information.
If Medium-mobility state is detected,
   Add the sf-Medium of “Speed dependent ScalingFactor for Qhyst” to Qhyst if broadcasted in system information.
   For NR cells, multiply TreselectionNR by the sf-Medium of “Speed dependent ScalingFactor for TreselectionNR” if broadcasted in system information.
   For EUTRA cells, multiply TreselectionEUTRA by the sf-Medium of “Speed dependent ScalingFactor for TreselectionEUTRA” if broadcasted in system information.

For reference, in the case where the scaling is applied to any TreselectionRAT parameter, the UE shall round up the result after all scalings to the nearest second.

In step 1g-20, the UE may perform the cell reselection process specified in step 1g-15 by reflecting the scaling result according to the determined mobility state.

In step 1g-25, the UE 1g-01 in RRC idle mode or RRC inactive mode may initiate an RRC connection establishment procedure or an RRC connection resume procedure to establish an RRC connection with the base station 1g-02. That is, in step 1g-25, the UE may transmit an RRC connection request message (RRCSetupRequest) or an RRC connection resume request message (RRCResumeRequest or RRCResumeRequest1) to the base station. In step 1g-30, the base station may transmit an RRC connection setup message (RRCSetup) or an RRC connection resume message (RRCResume) to the UE in response to the RRC connection request message or the RRC connection resume request message. The UE that has received the RRC connection setup message or the RRC connection resume message may transition to RRC connected mode (RRC_CONNECTED) in step 1g-31. Then, in step 1g-35, the UE in RRC connected mode may transmit an RRC connection setup complete message (RRCSetupComplete) or an RRC connection resume complete message (RRCResumeComplete) to the base station. At this time, the RRC connection setup complete message or the RRC connection resume complete message may include the mobility state of the UE. Specifically, the RRC connection setup complete message or the RRC connection resume complete message may include the mobilityState and set it to the mobility state (as specified in TS 38.304) of the UE just prior to entering RRC_CONNECTED state.

FIG. 1H is a flowchart illustrating a process in which a UE reports a mobility state to an NR base station in a next-generation mobile communication system according to an embodiment of the disclosure.

The UE in the next-generation mobile communication system according to this embodiment may mean a UE capable of receiving uncrewed aerial vehicle (UAV) services. Alternatively, the UE in the next-generation mobile communication system according to this embodiment may mean a UE capable of flying or moving at high speed or a UE capable of applying a newly defined mobility state determination method. The UE capable of receiving UAV services may satisfy the following requirements specified in 3GPP TS 22.125. In particular, the UE can receive UAV services while moving at high speed. In the case of complying with the typical mobility state determination, the UE moving at a high speed may enter the medium mobility state or the high mobility state much later despite its high speed.

For example, if the entry criteria for a UE moving at a high speed and a UE moving at a low speed into the medium or high mobility state are based on the same number of cell reselections, the UE moving at a high speed may enter the medium mobility state or the high mobility state at the same time as the UE moving at a low speed even though it has a higher speed than the UE moving at a low speed.

Accordingly, in this embodiment, a mobility state determination method for the above UE is proposed.

| | | Typical | | Max UAV | | Typical | | | | | Positive |
|---|---|---|---|---|---|---|---|---|---|---|---|
| | | Message | | ground | | message Size | | End to end | | Reliability | ACK |
| Control Mode | Function | Interval | | speed | | (note 1) | | Latency | | (note 2) | (note 8) |
| Steer to | UAV terminated | >=1 | s | 300 | km/h | 100 | byte | 1 | s | 99.9% | Required |
| waypoints | C2 message | | | | | | | | | | |
| (note 3) | UAV originated | 1 | s | | | 84-140 | byte | 1 | s | 99.9% | Not |
| | C2 message | | | | | | | | | | Required |
| | (note 4) | | | | | | | | | | |
| Direct stick | UAV terminated | 40 ms | | 60 | km/h | 24 | byte | 40 | ms | 99.9% | Required |
| steering | C2 message | (note 6) | | | | | | | | | |
| (note 5) | UAV originated | 40 | ms | | | 84-140 | byte | 40 | ms | 99.9% | Not |
| | C2 message | | | | | | | | | | Required |
| | (note 7) | | | | | | | | | | |
| Automatic | UAV terminated | 1 | s | 300 | km/h | <10 | kbyte | 5 s | | 99.9% | Required |
| flight | C2 message | | | | | | | (note 9) | | | |
| on UTM | UAV originated | 1 s | | | | 1500 | byte | 5 s | | 99.9% | Required |
| (note 10) | C2 message | (note 9) | | | | | | (note 9) | | | |
| Approaching | UAV terminated | 500 | ms | 50 | km/h | 4 | kbyte | 10 | ms | 99% | Required |
| Autonomous | C2 message | | | | | | | | | | |
| Navigation | UAVoriginated | 500 | ms | | | 4 | kbyte | 140 | ms | 99.99% | Required |
| Infrastructure | C2 message | | | | | | | | | | |

note 1:
Message size is at the application layer and excludes any headers and security related load. The numbers shown are typical as message size depends on the commands sent and is implementation specific.
note 2:
Message reliability is defined as the probability of successful transmission within the required latency at the application layer while under network coverage.
note 3:
Video is neither required nor expected to be used for steering in this mode.
note 4:
It may be possible to transmit this message on an event driven basis (e.g. approaching a geo fence). A status message may, but is not required to, be sent as a response to a control message.
note 5:
A video feedback is required for this mode. The KPIs for video are defined in table 7.2-2.
note 6:
UAVs on-board controllers typically update at either 50 Hz (20 ms) or 25 Hz (40 ms).
note 7:
A status message may, but is not required to, be sent as a response to a control message A 1 Hz slow mode also exists.
note 8:
Positive ACK is sent to the originator of the message (i.e. UAV controller and/or the UTM). The 5G system makes no assumption whether an appropriate ACK is sent by the application layer.
note 9:
At the application layer, the C2 communication between a UAV and UTM can be allowed to experience much longer traffic interruptions, e.g. timeouts of 30 s on the uplink and 300 s on the downlink.
note 10:
This only represents periodic message exchange during a nominal mission in steady state. Itdoes not represent unusual or aperiodic events such as conveying dynamic restrictions or a flight plan to the UAV on the downlink.

With reference to FIG. 1H, in step 1h-03, the UE 1h-01 may establish an RRC connection with the NR cell 1h-02 and thus be in RRC connected mode (RRC_CONNECTED).

In step 1h-04, the UE 1h-01 in RRC connected mode may transmit a UE capability information message (UECapabilityInformation) to the NR cell 1h-02. This message may include at least one of the following.
Indicator supporting enhanced mobility state determination
Indicator indicating a UAV UE
Indicator indicating that new speed dependent reselection parameters included in system information or RRC connection release message can be applied

In step 1h-05, the NR cell 1h-02 may transmit an RRC connection release message (RRCRelease) to the UE 1h-01 in RRC connected mode. This message may include new speed dependent reselection parameters. The new speed dependent reselection parameters may refer to at least one of the following.
t-ReselectionRATUAV: This specifies a cell reselection timer value. A value for a specific cell reselection timer may be defined for each target NR frequency or each RAT. Typical t-ReselectionRAT can be set to one of 0, 1 . . . 7, but the t-ReselectionRATUAV can be set to a value smaller than the typical t-ReselectionRAT or to one of various smaller values. For example, the t-ReselectionRATUAV can be set to one value from among 0, 0.1, 0.2, 0.3, 0.4 . . . 1.
   A timer value for NR refers to t-ReselectionNRUAV, and this timer value can be configured for each frequency.
   A timer value for E-UTRA refers to t-ReselectionEUTRAUAV, and this timer value can be configured to be applied to each-UTRA frequency or commonly applied to E-UTRA frequencies.
   Because the t-ReselectionRATUAV can be set to a value smaller than the typical t-ReselectionRAT or to various smaller values, the UE of the disclosure can perform cell reselection more quickly. For example, when the t-ReselectionRATUAV is set to one value from among 0, 0.1, 0.2, 0.3, 0.4 . . . 1, the UE of the disclosure moving at a high speed has a cell reselection timer value lower than that of the typical normal UE moving at a low speed, and thus it can enter the medium mobility state or the high mobility state more quickly than the typical normal UE that moves at a low speed.
t-EvaluationUAV: The duration of evaluating criteria to enter mobility states. For example, one of values such as 5 seconds, 10 seconds, 20 seconds, 30 seconds, 60 seconds, 120 seconds, 180 seconds, or 240 seconds may be signaled. This parameter may include a value smaller than that of the typical t-Evaluation. This is to enable the UE according to the disclosure to enter the medium mobility state or the high mobility state more quickly.
   The t-EvaluationUAV may refer to T_{CRmaxUAV}, and this specifies the duration for evaluating allowed amount of cell selection(s).
t-HystNormalUAV: The additional duration for evaluating criteria to enter normal mobility state. For example, one of values such as 5 seconds, 10 seconds, 30 seconds, 60 seconds, 120 seconds, 180 seconds, 240 seconds, or 360 seconds may be signaled. This parameter may include a value smaller or larger than the typical t-HystNormal. The reason for including a small value is for the UE to quickly transition to the normal mobility state, and the reason for including a large value is for the UE to slowly transition to the normal mobility state.
   The t-HystNormalUAV may refer to T_{CRmaxHystUAV}, and this specifies the additional time period before the UE can enter Normal-mobility state.
n-CellChangeMediumUAV: The number of cell changes to enter medium mobility state. For example, one of integer values from 1 (or from 0) to 16 may be signaled. This parameter may include a value smaller than that of the typical n-CellChangeMedium. This is to enable the UE according to the disclosure to enter the medium mobility state more quickly.
   The n-CellChangeMediumUAV may refer to N_{CR_MUAV}, and this specifies the maximum number of cell reselections to enter Medium-mobility state.
n-CellChangeHighUAV: The number of cell changes to enter high mobility state. For example, one of integer values from 1 (or from 0) to 16 may be signaled, and a value greater than that of the n-CellChangeMediumUAV may be signaled. This parameter may include a value smaller than the typical n-CellChangeHigh. This is to enable the UE according to the disclosure to enter the high mobility state more quickly.
   The n-CellChangeHigh may refer to N_{CR_H}, and this specifies the maximum number of cell reselections to enter High-mobility state.
q-HystSFUAV: Speed-based ScalingFactor parameter
   sf-MediumUAV: An additional hysteresis parameter value used in medium mobility state. For example, one value from among −10 dB, −8 dB, −6 dB, −4 dB, −2 dB, and 0 dB may be signaled. This parameter may include a smaller value than that of the typical sf-Medium, and this is intended to facilitate the UE to reselect a neighbor cell.
   sf-HighUAV: An additional hysteresis parameter value used in high mobility state. one value from among −10 dB, −8 dB, −6 dB, −4 dB, −2 dB, and 0 dB may be signaled. This parameter may include a value smaller than that of the typical sf-High, and this is intended to facilitate the UE to reselect a neighbor cell.
t-Reselection-SFUAV (per NR frequency): SpeedStateScaleFactors parameter
   sf-MediumUAV: An additional mobility control related parameter value used in medium mobility state. For example, one value from among 0.1, 0.125, 0.25, 0.5, 0.75, and 1 may be signaled. This parameter may include a smaller value than that of the typical sf-Medium, and this is intended to facilitate the UE to reselect a neighbor cell.
   sf-HighUAV: An additional mobility control related parameter value used in high mobility state. For example, one value from among 0.1, 0.125, 0.25, 0.5, 0.75, and 1 may be signaled. This parameter may include a value smaller than that of the typical sf-High, and this is intended to facilitate the UE to reselect a neighbor cell.
t-ReselectionEUTRA-SFUAV (per EUTRA frequency or common for all EUTRA frequencies): SpeedStateScaleFactors parameter
   sf-MediumUAV: An additional mobility control related parameter value used in medium mobility state. For example, one value from among 0.1, 0.125, 0.25, 0.5, 0.75, and 1 may be signaled. This parameter may include a smaller value than that of the typical sf-Medium, and this is intended to facilitate reselection of neighbor cells.
   sf-HighUAV: An additional mobility control related parameter value used in high mobility state. For example, one value from among 0.25, 0.5, 0.75, and 1 may be signaled. For example, one value from among 0.1, 0.125, 0.25, 0.5, 0.75, and 1 may be signaled. This parameter may include a value smaller than that of the typical sf-High, and this is intended to facilitate the UE to reselect a neighbor cell.
A value indicating how many seconds after the UE camps on the serving cell, cell reselection is possible.
   Typically, reselection to a neighbor cell is possible after one second has elapsed since the UE camped on the current serving cell, but the new value includes a value less than one second so that the UE according to the disclosure can reselect a neighbor cell more quickly than one second.
New timer value
   New timer value indicating the time to apply the new speed dependent reselection parameters described above. If a new timer value is included, the UE according to the disclosure can drive a new timer with the new timer value.

In step 1h-06, the UE 1h-01 receiving the RRC connection release message may transition to RRC idle mode (RRC_IDLE) or RRC inactive mode (RRC_INACTIVE).

In step 1h-10, the UE 1h-01 in RRC idle mode or RRC inactive mode may receive or obtain system information from the base station 1h-02. The system information may include parameters for the UE to perform a cell selection or cell reselection process. This may follow the above-described embodiment. Additionally, the base station 1h-02 may broadcast the system information including new parameters (speedStateReselectionParsUAV) for determining the mobility state of the UE.
t-ReselectionRATUAV: This specifies a cell reselection timer value. A value for a specific cell reselection timer may be defined for each target NR frequency or each RAT. Typical t-ReselectionRAT can be set to one of 0, 1 . . . 7, but the t-ReselectionRATUAV can be set to a value smaller than the typical t-ReselectionRAT or to one of various smaller values. For example, it may be set to one value from among 0, 0.1, 0.2, 0.3, 0.4 . . . 1.
   A timer value for NR refers to t-ReselectionNRUAV, and this timer value can be configured for each frequency.
   A timer value for E-UTRA refers to t-ReselectionEUTRAUAV, and this timer value can be configured to be applied to each-UTRA frequency or commonly applied to E-UTRA frequencies.
   Because can be set to a value smaller than the typical t-ReselectionRAT or to various smaller values, the UE of the disclosure can perform cell reselection more quickly.
t-EvaluationUAV: The duration of evaluating criteria to enter mobility states. For example, one of values such as 5 seconds, 10 seconds, 20 seconds, 30 seconds, 60 seconds, 120 seconds, 180 seconds, or 240 seconds may be signaled. This parameter may include a value smaller than that of the typical t-Evaluation. This is to enable the UE according to the disclosure to enter the medium mobility state or the high mobility state more quickly.
   The t-EvaluationUAV may refer to T_{CRmaxUAV}, and this specifies the duration for evaluating allowed amount of cell selection(s).
t-HystNormalUAV: The additional duration for evaluating criteria to enter normal mobility state. For example, one of values such as 5 seconds, 10 seconds, 30 seconds, 60 seconds, 120 seconds, 180 seconds, 240 seconds, or 360 seconds may be signaled. This parameter may include a value smaller or larger than the typical t-HystNormal. The reason for including a small value is for the UE to quickly transition to the normal mobility state, and the reason for including a large value is for the UE to slowly transition to the normal mobility state.
   The t-HystNormalUAV may refer to T_{CRmaxHystUAV}, and this specifies the additional time period before the UE can enter Normal-mobility state.
n-CellChangeMediumUAV: The number of cell changes to enter medium mobility state. For example, one of integer values from 1 (or from 0) to 16 may be signaled. This parameter may include a value smaller than that of the typical n-CellChangeMedium. This is to enable the UE according to the disclosure to enter the medium mobility state more quickly.
   The n-CellChangeMediumUAV may refer to N_{CR_MUAV}, and this specifies the maximum number of cell reselections to enter Medium-mobility state.
n-CellChangeHighUAV: The number of cell changes to enter high mobility state. For example, one of integer values from 1 (or from 0) to 16 may be signaled, and a value greater than that of the n-CellChangeMediumUAV may be signaled. This parameter may include a value smaller than the typical n-CellChangeHigh. This is to enable the UE according to the disclosure to enter the high mobility state more quickly.
   The n-CellChangeHigh may refer to N_{CR_H}, and this specifies the maximum number of cell reselections to enter High-mobility state.
q-HystSFUAV: Speed-based ScalingFactor parameter
   sf-MediumUAV: An additional hysteresis parameter value used in medium mobility state. For example, one value from among −10 dB, −8 dB, −6 dB, −4 dB, −2 dB, and 0 dB may be signaled. This parameter may include a smaller value than that of the typical sf-Medium, and this is intended to facilitate the UE to reselect a neighbor cell.
   sf-HighUAV: An additional hysteresis parameter value used in high mobility state. one value from among −10 dB, −8 dB, −6 dB, −4 dB, −2 dB, and 0 dB may be signaled. This parameter may include a value smaller than that of the typical sf-High, and this is intended to facilitate the UE to reselect a neighbor cell.
t-Reselection-SFUAV (per NR frequency): SpeedStateScaleFactors parameter
   sf-MediumUAV: An additional mobility control related parameter value used in medium mobility state. For example, one value from among 0.1, 0.125, 0.25, 0.5, 0.75, and 1 may be signaled. This parameter may include a smaller value than that of the typical sf-Medium, and this is intended to facilitate the UE to reselect a neighbor cell.
   sf-HighUAV: An additional mobility control related parameter value used in high mobility state. For example, one value from among 0.1, 0.125, 0.25, 0.5, 0.75, and 1 may be signaled. This parameter may include a value smaller than that of the typical sf-High, and this is intended to facilitate the UE to reselect a neighbor cell.
t-ReselectionEUTRA-SFUAV (per EUTRA frequency or common for all EUTRA frequencies): SpeedStateScaleFactors parameter
   sf-MediumUAV: An additional mobility control related parameter value used in medium mobility state. For example, one value from among 0.1, 0.125, 0.25, 0.5, 0.75, and 1 may be signaled. This parameter may include a smaller value than that of the typical sf-Medium, and this is intended to facilitate reselection of neighbor cells.
   sf-HighUAV: An additional mobility control related parameter value used in high mobility state. For example, one value from among 0.25, 0.5, 0.75, and 1 may be signaled. For example, one value from among 0.1, 0.125, 0.25, 0.5, 0.75, and 1 may be signaled. This parameter may include a value smaller than that of the typical sf-High, and this is intended to facilitate the UE to reselect a neighbor cell.
A value indicating how many seconds after the UE camps on the serving cell, cell reselection is possible.
   Typically, reselection to a neighbor cell is possible after one second has elapsed since the UE camped on the current serving cell, but the new value includes a value less than one second so that the UE according to the disclosure can reselect a neighbor cell more quickly than one second.

In step 1h-15, the UE 1h-01 in RRC idle mode or RRC inactive mode may perform a cell selection or cell reselection process. This can be performed by following the above-described embodiment or by applying at least one of the parameters described above in step 1h-10.

In step 1h-20, the UE 1h-01 in RRC idle mode or RRC inactive mode may determine the mobility state. In the case that the UE supporting UAV acquires new speed dependent reselection parameters in step 1h-05 or step 1h-10, it may determine the mobility state according to predetermined criteria based on the new speed dependent reselection parameters. For reference, if new speed dependent reselection parameters are configured in step 1h-05, the UE may apply the new speed dependent reselection parameters included in the RRC connection release message.
Medium-mobility state criteria
   If the number of cell reselections during time period T_{CRmax} (or T_{CRmaxUAV}) is greater than or equal to N_{CR_M} (or N_{CR_MUAV}) but less than or equal to N_{CR_H} (or N_{CR_H-UAV})
High-mobility state criteria
   If the number of cell reselections during time period T_{CRmax} (or T_{CRmaxUAV}) is greater than N_{CR_H} (or N_{CR_H-UAV})
Normal-mobility state criteria
   If criteria for either Medium- or High-mobility state is not detected during time period T_{CRmaxHystUAV} or T_{CRmaxHyst}, or if the number of cell reselections during time period T_{CRmaxUAV} (or T_{CRmax}) is less than N_{CR_M} (or N_{CR_MUAV})

The UE may perform a cell reselection process by applying a scaling rule according to the determined mobility state. Specifically,
If neither Medium- nor High-mobility state is detected,
   No scaling is applied.
If high-mobility state is detected,
   Add the sf-HighUAV (or sf-High) of “Speed dependent ScalingFactor for Qhyst” to Qhyst if broadcasted in system information.
   For NR cells, multiply TreselectionNRUAV (or TreselectionNR) by the sf-HighUAV (or sf-High) of “Speed dependent ScalingFactor for TreselectionNRUAV (or TreselectionNR)” if broadcasted in system information.
   For EUTRA cells, multiply TreselectionEUTRAUAV (or TreselectionEUTRA) by the sf-HighUAV (or sf-High) of “Speed dependent ScalingFactor for TreselectionEUTRAUAV (or TreselectionEUTRA)” if broadcasted in system information.
If Medium-mobility state is detected,
   Add the sf-MediumUAV (or sf-Medium) of “Speed dependent ScalingFactor for Qhyst” to Qhyst if broadcasted in system information.
   For NR cells, multiply TreselectionNRUAV (or TreselectionNR) by the sf-Medium UAV (or sf-Medium) of “Speed dependent ScalingFactor for TreselectionNRUAV (or TreselectionNR)” if broadcasted in system information.
   For EUTRA cells, multiply TreselectionEUTRAUAV (or TreselectionEUTRA) by the sf-MediumUAV (sf-Medium) of “Speed dependent ScalingFactor for TreselectionEUTRAUAV (or TreselectionEUTRA)” if broadcasted in system information.

For reference, in the case where the scaling is applied to any TreselectionRAT parameter, the UE shall round up the result after all scalings to the nearest second.

For reference, if a UE that supports UAV or a UE that does not support UAV fails to acquire new speed dependent reselection parameters in step 1h-05 or step 1h-10, it may determine the mobility state based on the above-described embodiment.

In step 1h-20, the UE may perform the cell reselection process specified in step 1h-15 by reflecting the scaling result according to the determined mobility state.

In step 1h-25, the UE 1h-01 in RRC idle mode or RRC inactive mode may initiate an RRC connection establishment procedure or an RRC connection resume procedure to establish an RRC connection with the base station 1h-02. That is, in step 1h-25, the UE may transmit an RRC connection request message (RRCSetupRequest) or an RRC connection resume request message (RRCResumeRequest or RRCResumeRequest1) to the base station. In step 1h-30, the base station may transmit an RRC connection setup message (RRCSetup) or an RRC connection resume message (RRCResume) to the UE in response to the RRC connection request message or the RRC connection resume request message. The UE that has received the RRC connection setup message or the RRC connection resume message may transition to RRC connected mode (RRC_CONNECTED) in step 1h-31. Then, in step 1h-35, the UE in RRC connected mode may transmit an RRC connection setup complete message (RRCSetupComplete) or an RRC connection resume complete message (RRCResumeComplete) to the base station. At this time, the RRC connection setup complete message or the RRC connection resume complete message may include a UE's new mobility state (mobility state for UAV) or the typical mobility state. Specifically, the RRC connection setup complete message or the RRC connection resume complete message may include the mobilityStateUAV or mobilityState and set it to the mobility state (as specified in TS 38.304) of the UE just prior to entering RRC_CONNECTED state.

According to the disclosure, in the case of a UAV UE, if new speed dependent reselection parameters are broadcasted or configured, the UAV UE can determine the mobility state or perform cell reselection by applying the new speed dependent reselection parameters. Even in the case of the UAV UE, if it does not have the new speed dependent reselection parameters, it can determine the mobility state or perform cell reselection according to the typical method.

FIG. 1I is a flowchart illustrating a process in which a UE reports a mobility state to an NR base station in a next-generation mobile communication system according to an embodiment of the disclosure.

The UE in the next-generation mobile communication system according to this embodiment may mean a UE capable of receiving uncrewed aerial vehicle (UAV) services. Alternatively, the UE in the next-generation mobile communication system according to this embodiment may mean a UE capable of flying or moving at high speed or a UE capable of applying a newly defined mobility state determination method. The UE capable of receiving UAV services may satisfy the following requirements specified in 3GPP TS 22.125. In particular, the UE can receive UAV services while moving at high speed. In the case of complying with the typical mobility state determination, the UE moving at a high speed may enter the medium mobility state or the high mobility state much later despite its high speed. Accordingly, in this embodiment, a mobility state determination method for the above UE is proposed.

| | | Typical | | Max UAV | | Typical | | | | | Positive |
|---|---|---|---|---|---|---|---|---|---|---|---|
| | | Message | | ground | | message Size | | End to end | | Reliability | ACK |
| Control Mode | Function | Interval | | speed | | (note 1) | | Latency | | (note 2) | (note 8) |
| Steer to | UAV terminated | >=1 | s | 300 | km/h | 100 | byte | 1 | s | 99.9% | Required |
| waypoints | C2 message | | | | | | | | | | |
| (note 3) | UAV originated | 1 | s | | | 84-140 | byte | 1 | s | 99.9% | Not |
| | C2 message | | | | | | | | | | Required |
| | (note 4) | | | | | | | | | | |
| Direct stick | UAV terminated | 40 ms | | 60 | km/h | 24 | byte | 40 | ms | 99.9% | Required |
| steering | C2 message | (note 6) | | | | | | | | | |
| (note 5) | UAV originated | 40 | ms | | | 84-140 | byte | 40 | ms | 99.9% | Not |
| | C2 message | | | | | | | | | | Required |
| | (note 7) | | | | | | | | | | |
| Automatic | UAV terminated | 1 | s | 300 | km/h | <10 | kbyte | 5 s | | 99.9% | Required |
| flight | C2 message | | | | | | | (note 9) | | | |
| on UTM | UAV originated | 1 s | | | | 1500 | byte | 5 s | | 99.9% | Required |
| (note 10) | C2 message | (note 9) | | | | | | (note 9) | | | |
| Approaching | UAV terminated | 500 | ms | 50 | km/h | 4 | kbyte | 10 | ms | 99% | Required |
| Autonomous | C2 message | | | | | | | | | | |
| Navigation | UAVoriginated | 500 | ms | | | 4 | kbyte | 140 | ms | 99.99% | Required |
| Infrastructure | C2 message | | | | | | | | | | |

note 1:
Message size is at the application layer and excludes any headers and security related load. The numbers shown are typical as message size depends on the commands sent and is implementation specific.
note 2:
Message reliability is defined as the probability of successful transmission within the required latency at the application layer while under network coverage.
note 3:
Video is neither required nor expected to be used for steering in this mode.
note 4:
It may be possible to transmit this message on an event driven basis (e.g. approaching a geo fence). A status message may, but is not required to, be sent as a response to a control message.
note 5:
A video feedback is required for this mode. The KPIs for video are defined in table 7.2-2.
note 6:
UAVs on-board controllers typically update at either 50 Hz (20 ms) or 25 Hz (40 ms).
note 7:
A status message may, but is not required to, be sent as a response to a control message A 1iz slow mode also exists.
note 8:
Positive ACK is sent to the originator of the message (i.e. UAV controller and/or the UTM). The 5G system makes no assumption whether an appropriate ACK is sent by the application layer.
note 9:
At the application layer, the C2 communication between a UAV and UTM can be allowed to experience much longer traffic interruptions, e.g. timeouts of 30 s on the uplink and 300 s on the downlink.
note 10:
This only represents periodic message exchange during a nominal mission in steady state. Itdoes not represent unusual or aperiodic events such as conveying dynamic restrictions or a flight plan to the UAV on the downlink.

With reference to FIG. 1I, in step 1i-03, the UE 1i-01 may establish an RRC connection with the NR cell 1i-02 and thus be in RRC connected mode (RRC_CONNECTED).

In step 1i-04, the UE 1i-01 in RRC connected mode may transmit a UE capability information message (UECapabilityInformation) to the NR cell 1i-02. This message may include at least one of the following.
Indicator supporting enhanced mobility state determination
Indicator indicating a UAV UE
Indicator indicating that new speed dependent reselection parameters included in system information or RRC connection release message can be applied
Indicator indicating that the enhanced mobility state can be determined according to speed

In step 1i-05, the NR cell 1i-02 may transmit an RRC connection release message (RRCRelease) to the UE 1i-01 in RRC connected mode. This message may include new speed dependent reselection parameters. The new speed dependent reselection parameters may refer to at least one of the following.
t-ReselectionRATUAV: This specifies a cell reselection timer value. A value for a specific cell reselection timer may be defined for each target NR frequency or each RAT. Typical t-ReselectionRAT can be set to one of 0, 1 . . . 7, but the t-ReselectionRATUAV can be set to a value smaller than the typical t-ReselectionRAT or to one of various smaller values. For example, the t-ReselectionRATUAV can be set to one value from among 0, 0.1, 0.2, 0.3, 0.4 . . . 1.
   A timer value for NR refers to t-ReselectionNRUAV, and this timer value can be configured for each frequency.
   A timer value for E-UTRA refers to t-ReselectionEUTRAUAV, and this timer value can be configured to be applied to each-UTRA frequency or commonly applied to E-UTRA frequencies.
   Because the t-ReselectionRATUAV can be set to a value smaller than the typical t-ReselectionRAT or to various smaller values, the UE of the disclosure can perform cell reselection more quickly. For example, when the t-ReselectionRATUAV is set to one value from among 0, 0.1, 0.2, 0.3, 0.4 . . . 1, the UE of the disclosure moving at a high speed has a cell reselection timer value lower than that of the typical normal UE moving at a low speed, and thus it can enter the medium mobility state or the high mobility state more quickly than the typical normal UE that moves at a low speed.
t-EvaluationUAV: The duration of evaluating criteria to enter mobility states. For example, one of values such as 5 seconds, 10 seconds, 20 seconds, 30 seconds, 60 seconds, 120 seconds, 180 seconds, or 240 seconds may be signaled. This parameter may include a value smaller than that of the typical t-Evaluation. This is to enable the UE according to the disclosure to enter the medium mobility state or the high mobility state more quickly.
   The t-EvaluationUAV may refer to T_{CRmaxUAV}, and this specifies the duration for evaluating allowed amount of cell selection(s).
t-HystNormalUAV: The additional duration for evaluating criteria to enter normal mobility state. For example, one of values such as 5 seconds, 10 seconds, 30 seconds, 60 seconds, 120 seconds, 180 seconds, 240 seconds, or 360 seconds may be signaled. This parameter may include a value smaller or larger than the typical t-HystNormal. The reason for including a small value is for the UE to quickly transition to the normal mobility state, and the reason for including a large value is for the UE to slowly transition to the normal mobility state.
   The t-HystNormalUAV may refer to T_{CRmaxHystUAV}, and this specifies the additional time period before the UE can enter Normal-mobility state.
n-CellChangeMediumUAV: The number of cell changes to enter medium mobility state. For example, one of integer values from 1 (or from 0) to 16 may be signaled. This parameter may include a value smaller than that of the typical n-CellChangeMedium. This is to enable the UE according to the disclosure to enter the medium mobility state more quickly.
   The n-CellChangeMediumUAV may refer to N_{CR_MUAV}, and this specifies the maximum number of cell reselections to enter Medium-mobility state.
n-CellChangeHighUAV: The number of cell changes to enter high mobility state. For example, one of integer values from 1 (or from 0) to 16 may be signaled, and a value greater than that of the n-CellChangeMediumUAV may be signaled. This parameter may include a value smaller than the typical n-CellChangeHigh. This is to enable the UE according to the disclosure to enter the high mobility state more quickly.
   The n-CellChangeHigh may refer to N_{CR_H}, and this specifies the maximum number of cell reselections to enter High-mobility state.
q-HystSFUAV: Speed-based ScalingFactor parameter
   sf-MediumUAV: An additional hysteresis parameter value used in medium mobility state. For example, one value from among −10 dB, −8 dB, −6 dB, −4 dB, −2 dB, and 0 dB may be signaled. This parameter may include a smaller value than that of the typical sf-Medium, and this is intended to facilitate the UE to reselect a neighbor cell.
   sf-HighUAV: An additional hysteresis parameter value used in high mobility state. one value from among −10 dB, −8 dB, −6 dB, −4 dB, −2 dB, and 0 dB may be signaled. This parameter may include a value smaller than that of the typical sf-High, and this is intended to facilitate the UE to reselect a neighbor cell.
t-Reselection-SFUAV (per NR frequency): SpeedStateScaleFactors parameter
   sf-MediumUAV: An additional mobility control related parameter value used in medium mobility state. For example, one value from among 0.1, 0.125, 0.25, 0.5, 0.75, and 1 may be signaled. This parameter may include a smaller value than that of the typical sf-Medium, and this is intended to facilitate the UE to reselect a neighbor cell.
   sf-HighUAV: An additional mobility control related parameter value used in high mobility state. For example, one value from among 0.1, 0.125, 0.25, 0.5, 0.75, and 1 may be signaled. This parameter may include a value smaller than that of the typical sf-High, and this is intended to facilitate the UE to reselect a neighbor cell.
t-ReselectionEUTRA-SFUAV (per EUTRA frequency or common for all EUTRA frequencies): SpeedStateScaleFactors parameter
   sf-MediumUAV: An additional mobility control related parameter value used in medium mobility state. For example, one value from among 0.1, 0.125, 0.25, 0.5, 0.75, and 1 may be signaled. This parameter may include a smaller value than that of the typical sf-Medium, and this is intended to facilitate reselection of neighbor cells.
   sf-HighUAV: An additional mobility control related parameter value used in high mobility state. For example, one value from among 0.25, 0.5, 0.75, and 1 may be signaled. For example, one value from among 0.1, 0.125, 0.25, 0.5, 0.75, and 1 may be signaled. This parameter may include a value smaller than that of the typical sf-High, and this is intended to facilitate the UE to reselect a neighbor cell.
A value indicating how many seconds after the UE camps on the serving cell, cell reselection is possible.
   Typically, reselection to a neighbor cell is possible after one second has elapsed since the UE camped on the current serving cell, but the new value includes a value less than one second so that the UE according to the disclosure can reselect a neighbor cell more quickly than one second.
New timer value
   New timer value indicating the time to apply the new speed dependent reselection parameters described above. If a new timer value is included, the UE according to the disclosure can drive a new timer with the new timer value.
Speed threshold value
   If the speed of the UE is greater than a speed threshold, new speed dependent reselection parameters may be applied. Otherwise, typical speed dependent reselection parameters may be applied.

In step 1i-06, the UE 1i-01 receiving the RRC connection release message may transition to RRC idle mode (RRC_IDLE) or RRC inactive mode (RRC_INACTIVE).

In step 1i-10, the UE 1i-01 in RRC idle mode or RRC inactive mode may receive or obtain system information from the base station 1i-02. The system information may include parameters for the UE to perform a cell selection or cell reselection process. This may follow the above-described embodiment. Additionally, the base station 1i-02 may broadcast the system information including new parameters (speedStateReselectionParsUAV) for determining the mobility state of the UE.
t-ReselectionRATUAV: This specifies a cell reselection timer value. A value for a specific cell reselection timer may be defined for each target NR frequency or each RAT. Typical t-ReselectionRAT can be set to one of 0, 1 . . . 7, but the t-ReselectionRATUAV can be set to a value smaller than the typical t-ReselectionRAT or to one of various smaller values. For example, the t-ReselectionRATUAV may be set to one value from among 0, 0.1, 0.2, 0.3, 0.4 . . . 1.
   A timer value for NR refers to t-ReselectionNRUAV, and this timer value can be configured for each frequency.
   A timer value for E-UTRA refers to t-ReselectionEUTRAUAV, and this timer value can be configured to be applied to each-UTRA frequency or commonly applied to E-UTRA frequencies.
   Because the t-ReselectionRATUAV can be set to a value smaller than the typical t-ReselectionRAT or to various smaller values, the UE of the disclosure can perform cell reselection more quickly. For example, when the t-ReselectionRATUAV is set to one value from among 0, 0.1, 0.2, 0.3, 0.4 . . . 1, the UE of the disclosure moving at a high speed has a cell reselection timer value lower than that of the typical normal UE moving at a low speed, and thus it can enter the medium mobility state or the high mobility state more quickly than the typical normal UE that moves at a low speed.
t-EvaluationUAV: The duration of evaluating criteria to enter mobility states. For example, one of values such as 5 seconds, 10 seconds, 20 seconds, 30 seconds, 60 seconds, 120 seconds, 180 seconds, or 240 seconds may be signaled. This parameter may include a value smaller than that of the typical t-Evaluation. This is to enable the UE according to the disclosure to enter the medium mobility state or the high mobility state more quickly.
   The t-EvaluationUAV may refer to T_{CRmaxUAV}, and this specifies the duration for evaluating allowed amount of cell selection(s).
t-HystNormalUAV: The additional duration for evaluating criteria to enter normal mobility state. For example, one of values such as 5 seconds, 10 seconds, 30 seconds, 60 seconds, 120 seconds, 180 seconds, 240 seconds, or 360 seconds may be signaled. This parameter may include a value smaller or larger than the typical t-HystNormal. The reason for including a small value is for the UE to quickly transition to the normal mobility state, and the reason for including a large value is for the UE to slowly transition to the normal mobility state.
   The t-HystNormalUAV may refer to T_{CRmaxHystUAV}, and this specifies the additional time period before the UE can enter Normal-mobility state.
n-CellChangeMediumUAV: The number of cell changes to enter medium mobility state. For example, one of integer values from 1 (or from 0) to 16 may be signaled. This parameter may include a value smaller than that of the typical n-CellChangeMedium. This is to enable the UE according to the disclosure to enter the medium mobility state more quickly.
   The n-CellChangeMediumUAV may refer to N_{CR_MUAV}, and this specifies the maximum number of cell reselections to enter Medium-mobility state.
n-CellChangeHighUAV: The number of cell changes to enter high mobility state. For example, one of integer values from 1 (or from 0) to 16 may be signaled, and a value greater than that of the n-CellChangeMediumUAV may be signaled. This parameter may include a value smaller than the typical n-CellChangeHigh. This is to enable the UE according to the disclosure to enter the high mobility state more quickly.
   The n-CellChangeHigh may refer to N_{CR_H}, and this specifies the maximum number of cell reselections to enter High-mobility state.
q-HystSFUAV: Speed-based ScalingFactor parameter
   sf-MediumUAV: An additional hysteresis parameter value used in medium mobility state. For example, one value from among −10 dB, −8 dB, −6 dB, −4 dB, −2 dB, and 0 dB may be signaled. This parameter may include a smaller value than that of the typical sf-Medium, and this is intended to facilitate the UE to reselect a neighbor cell.
   sf-HighUAV: An additional hysteresis parameter value used in high mobility state. one value from among −10 dB, −8 dB, −6 dB, −4 dB, −2 dB, and 0 dB may be signaled. This parameter may include a value smaller than that of the typical sf-High, and this is intended to facilitate the UE to reselect a neighbor cell.
t-Reselection-SFUAV (per NR frequency): SpeedStateScaleFactors parameter
   sf-MediumUAV: An additional mobility control related parameter value used in medium mobility state. For example, one value from among 0.1, 0.125, 0.25, 0.5, 0.75, and 1 may be signaled. This parameter may include a smaller value than that of the typical sf-Medium, and this is intended to facilitate the UE to reselect a neighbor cell.
   sf-HighUAV: An additional mobility control related parameter value used in high mobility state. For example, one value from among 0.1, 0.125, 0.25, 0.5, 0.75, and 1 may be signaled. This parameter may include a value smaller than that of the typical sf-High, and this is intended to facilitate the UE to reselect a neighbor cell.
t-ReselectionEUTRA-SFUAV (per EUTRA frequency or common for all EUTRA frequencies): SpeedStateScaleFactors parameter
   sf-MediumUAV: An additional mobility control related parameter value used in medium mobility state. For example, one value from among 0.1, 0.125, 0.25, 0.5, 0.75, and 1 may be signaled. This parameter may include a smaller value than that of the typical sf-Medium, and this is intended to facilitate reselection of neighbor cells.
   sf-HighUAV: An additional mobility control related parameter value used in high mobility state. For example, one value from among 0.25, 0.5, 0.75, and 1 may be signaled. For example, one value from among 0.1, 0.125, 0.25, 0.5, 0.75, and 1 may be signaled. This parameter may include a value smaller than that of the typical sf-High, and this is intended to facilitate the UE to reselect a neighbor cell.
A value indicating how many seconds after the UE camps on the serving cell, cell reselection is possible.
   Typically, reselection to a neighbor cell is possible after one second has elapsed since the UE camped on the current serving cell, but the new value includes a value less than one second so that the UE according to the disclosure can reselect a neighbor cell more quickly than one second.
Speed threshold value
   Depending on the speed threshold value, if the speed of the UE is faster than the speed threshold value or is equal to or faster than the speed threshold value, speed dependent reselection parameters can be applied. Otherwise, typical speed dependent reselection parameters can be applied.

In step 1i-15, the UE 1i-01 in RRC idle mode or RRC inactive mode may perform a cell selection or cell reselection process. This can be performed by following the above-described embodiment or by applying at least one of the parameters described above in step 1i-10.

In step 1i-20, the UE 1i-01 in RRC idle mode or RRC inactive mode may determine the mobility state. In the case that the UE supporting UAV acquires new speed dependent reselection parameters in step 1i-05 or step 1i-10, it may determine the mobility state according to predetermined criteria based on the new speed dependent reselection parameters depending on the speed threshold value (which may be acquired in step 1i-05 or step 1i-10 or determined directly in the UE). For reference, if new speed dependent reselection parameters are configured in step 1i-05, the UE may apply the new speed dependent reselection parameters included in the RRC connection release message.
Medium-mobility state criteria
   If the number of cell reselections during time period T_{CRmax} (or T_{CRmaxUAV}) is greater than or equal to N_{CR_M} (or N_{CR_MUAV}) but less than or equal to N_{CR_H} (or N_{CR_H-UAV})
High-mobility state criteria
   If the number of cell reselections during time period T_{CRmax} (or T_{CRmaxUAV}) is greater than N_{CR_H} (or N_{CR_H-UAV})
Normal-mobility state criteria
   If criteria for either Medium- or High-mobility state is not detected during time period T_{CRmaxHystUAV} or T_{CRmaxHyst}, or if the number of cell reselections during time period T_{CRmaxUAV} (or T_{CRmax}) is less than N_{CR_M} (or N_{CR_MUAV})

The UE may perform a cell reselection process by applying a scaling rule according to the determined mobility state. Specifically,
If neither Medium- nor High-mobility state is detected,
   No scaling is applied.
If high-mobility state is detected,
   Add the sf-HighUAV (or sf-High) of “Speed dependent ScalingFactor for Qhyst” to Qhyst if broadcasted in system information.
   For NR cells, multiply TreselectionNRUAV (or TreselectionNR) by the sf-HighUAV (or sf-High) of “Speed dependent ScalingFactor for TreselectionNRUAV (or TreselectionNR)” if broadcasted in system information.
   For EUTRA cells, multiply TreselectionEUTRAUAV (or TreselectionEUTRA) by the sf-HighUAV (or sf-High) of “Speed dependent ScalingFactor for TreselectionEUTRAUAV (or TreselectionEUTRA)” if broadcasted in system information.
If Medium-mobility state is detected,
   Add the sf-MediumUAV (or sf-Medium) of “Speed dependent ScalingFactor for Qhyst” to Qhyst if broadcasted in system information.
   For NR cells, multiply TreselectionNRUAV (or TreselectionNR) by the sf-Medium UAV (or sf-Medium) of “Speed dependent ScalingFactor for TreselectionNRUAV (or TreselectionNR)” if broadcasted in system information.
   For EUTRA cells, multiply TreselectionEUTRAUAV (or TreselectionEUTRA) by the sf-MediumUAV (sf-Medium) of “Speed dependent ScalingFactor for TreselectionEUTRAUAV (or TreselectionEUTRA)” if broadcasted in system information.

For reference, in the case where the scaling is applied to any TreselectionRAT parameter, the UE shall round up the result after all scalings to the nearest second.

For reference, if a UE that supports UAV or a UE that does not support UAV fails to acquire new speed dependent reselection parameters in step 1i-05 or step 1i-10, it may determine the mobility state based on the above-described embodiment. Also, even if the UE speed is slower than the speed threshold value or if it is equal to or slower than the speed threshold value, the mobility state can be determined using typical speed dependent reselection parameters.

In step 1i-20, the UE may perform the cell reselection process specified in step 1i-15 by reflecting the scaling result according to the determined mobility state.

In step 1i-25, the UE 1i-01 in RRC idle mode or RRC inactive mode may initiate an RRC connection establishment procedure or an RRC connection resume procedure to establish an RRC connection with the base station 1i-02. That is, in step 1i-25, the UE may transmit an RRC connection request message (RRCSetupRequest) or an RRC connection resume request message (RRCResumeRequest or RRCResumeRequest1) to the base station. In step 1i-30, the base station may transmit an RRC connection setup message (RRCSetup) or an RRC connection resume message (RRCResume) to the UE in response to the RRC connection request message or the RRC connection resume request message. The UE that has received the RRC connection setup message or the RRC connection resume message may transition to RRC connected mode (RRC_CONNECTED) in step 1i-31. Then, in step 1i-35, the UE in RRC connected mode may transmit an RRC connection setup complete message (RRCSetupComplete) or an RRC connection resume complete message (RRCResumeComplete) to the base station. At this time, the RRC connection setup complete message or the RRC connection resume complete message may include a UE's new mobility state (mobility state for UAV) or the typical mobility state. Specifically, the RRC connection setup complete message or the RRC connection resume complete message may include the mobilityStateUAV or mobilityState and set it to the mobility state (as specified in TS 38.304) of the UE just prior to entering RRC_CONNECTED state.

According to the disclosure, in the case where the UE speed is greater than the speed threshold value, it is possible to determine the mobility state or perform cell reselection by applying the new speed dependent reselection parameters. Even in the case where the UE speed is greater than the speed threshold value, if there are no new speed dependent reselection parameters, it is possible to determine the mobility state or perform cell reselection according to the typical method.

FIG. 1J is a flowchart illustrating a process in which a UE reports a mobility state to an NR base station in a next-generation mobile communication system according to an embodiment of the disclosure.

The UE in the next-generation mobile communication system according to this embodiment may mean a UE capable of receiving uncrewed aerial vehicle (UAV) services. Alternatively, the UE in the next-generation mobile communication system according to this embodiment may mean a UE capable of flying or moving at high speed or a UE capable of applying a newly defined mobility state determination method. The UE capable of receiving UAV services may satisfy the following requirements specified in 3GPP TS 22.125. In particular, the UE can receive UAV services while moving at high speed. In the case of complying with the typical mobility state determination, the UE moving at a high speed may enter the medium mobility state or the high mobility state much later despite its high speed. Accordingly, in this embodiment, a mobility state determination method for the above UE is proposed.

| | | Typical | | Max UAV | | Typical | | | | | Positive |
|---|---|---|---|---|---|---|---|---|---|---|---|
| | | Message | | ground | | message Size | | End to end | | Reliability | ACK |
| Control Mode | Function | Interval | | speed | | (note 1) | | Latency | | (note 2) | (note 8) |
| Steer to | UAV terminated | >=1 | s | 300 | km/h | 100 | byte | 1 | s | 99.9% | Required |
| waypoints | C2 message | | | | | | | | | | |
| (note 3) | UAV originated | 1 | s | | | 84-140 | byte | 1 | s | 99.9% | Not |
| | C2 message | | | | | | | | | | Required |
| | (note 4) | | | | | | | | | | |
| Direct stick | UAV terminated | 40 ms | | 60 | km/h | 24 | byte | 40 | ms | 99.9% | Required |
| steering | C2 message | (note 6) | | | | | | | | | |
| (note 5) | UAV originated | 40 | ms | | | 84-140 | byte | 40 | ms | 99.9% | Not |
| | C2 message | | | | | | | | | | Required |
| | (note 7) | | | | | | | | | | |
| Automatic | UAV terminated | 1 | s | 300 | km/h | <10 | kbyte | 5 s | | 99.9% | Required |
| flight | C2 message | | | | | | | (note 9) | | | |
| on UTM | UAV originated | 1 s | | | | 1500 | byte | 5 s | | 99.9% | Required |
| (note 10) | C2 message | (note 9) | | | | | | (note 9) | | | |
| Approaching | UAV terminated | 500 | ms | 50 | km/h | 4 | kbyte | 10 | ms | 99% | Required |
| Autonomous | C2 message | | | | | | | | | | |
| Navigation | UAVoriginated | 500 | ms | | | 4 | kbyte | 140 | ms | 99.99% | Required |
| Infrastructure | C2 message | | | | | | | | | | |

note 1:
Message size is at the application layer and excludes any headers and security related load. The numbers shown are typical as message size depends on the commands sent and is implementation specific.
note 2:
Message reliability is defined as the probability of successful transmission within the required latency at the application layer while under network coverage.
note 3:
Video is neither required nor expected to be used for steering in this mode.
note 4:
It may be possible to transmit this message on an event driven basis (e.g. approaching a geo fence). A status message may, but is not required to, be sent as a response to a control message.
note 5:
A video feedback is required for this mode. The KPIs for video are defined in table 7.2-2.
note 6:
UAVs on-board controllers typically update at either 50 Hz (20 ms) or 25 Hz (40 ms).
note 7:
A status message may, but is not required to, be sent as a response to a control message A 1jz slow mode also exists.
note 8:
Positive ACK is sent to the originator of the message (i.e. UAV controller and/or the UTM). The 5G system makes no assumption whether an appropriate ACK is sent by the application layer.
note 9:
At the application layer, the C2 communication between a UAV and UTM can be allowed to experience much longer traffic interruptions, e.g. timeouts of 30 s on the uplink and 300 s on the downlink.
note 10:
This only represents periodic message exchange during a nominal mission in steady state. Itdoes not represent unusual or aperiodic events such as conveying dynamic restrictions or a flight plan to the UAV on the downlink.

With reference to FIG. 1J, in step 1j-03, the UE 1j-01 may establish an RRC connection with the NR cell 1j-02 and thus be in RRC connected mode (RRC_CONNECTED).

In step 1j-04, the UE 1j-01 in RRC connected mode may transmit a UE capability information message (UECapabilityInformation) to the NR cell 1j-02. This message may include at least one of the following.
Indicator supporting enhanced mobility state determination
Indicator indicating a UAV UE
Indicator indicating that new speed dependent reselection parameters included in system information or RRC connection release message can be applied

In step 1j-05, the NR cell 1j-02 may transmit an RRC connection release message (RRCRelease) to the UE 1j-01 in RRC connected mode. This message may include new speed dependent reselection parameters. The new speed dependent reselection parameters may refer to at least one of the following.
κ for t-ReselectionRAT: This parameter refers to a scaling factor for typical t-ReselectionRAT. This parameter is multiplied or added to the typical parameter to enable the UE to perform cell reselection more quickly.
α for t-Evaluation: This parameter refers to a scaling factor for typical t-Evaluation. This parameter is multiplied or added to the typical parameter to enable the UE to determine the mobility state more quickly.
β for t-HystNormal: This parameter refers to a scaling factor for typical t-HystNormal. This parameter is multiplied or added to the typical parameter to enable the UE to transition to the normal mobility state more quickly or more slowly.
γ for n-CellChangeMedium: This parameter refers to a scaling factor for typical n-CellChangeMedium. This parameter is multiplied or added to the typical parameter to enable the UE to enter the medium mobility state more quickly.
δ for n-CellChangeHigh: This parameter refers to a scaling factor for typical n-CellChangeHigh. This parameter is multiplied or added to the typical parameter to enable the UE to enter the high mobility state more quickly.
q-HystSFUAV: Speed-based ScalingFactor parameter
   θ for sf-Medium: This parameter refers to a scaling factor for typical parameter sf-Medium. This parameter is multiplied or added to the typical parameter to enable the UE to reselect a neighbor cell more quickly.
   μ for sf-High: This parameter refers to a scaling factor for typical parameter sf-High. This parameter is multiplied or added to the typical parameter to enable the UE to reselect a neighbor cell more quickly.
t-Reselection-SF (per NR frequency): SpeedStateScaleFactors parameter
   ρ for sf-Medium: This parameter refers to a scaling factor for typical parameter sf-Medium. This parameter is multiplied or added to the typical parameter to enable the UE to reselect a neighbor cell more quickly.
   φ for sf-High: This parameter refers to a scaling factor for typical parameter sf-High. This parameter is multiplied or added to the typical parameter to enable the UE to reselect a neighbor cell more quickly.
t-ReselectionEUTRA-SF (per EUTRA frequency or common for all EUTRA frequencies): SpeedStateScaleFactors parameter
   ω for sf-Medium: This parameter refers to a scaling factor for typical parameter sf-Medium. This parameter is multiplied or added to the typical parameter to enable the UE to reselect a neighbor cell more quickly.
   τ for sf-High: This parameter refers to a scaling factor for typical parameter sf-High. This parameter is multiplied or added to the typical parameter to enable the UE to reselect a neighbor cell more quickly.
A value or scaling factor indicating how many seconds after the UE camps on the serving cell, cell reselection is possible.
   Typically, reselection to a neighbor cell is possible after one second has elapsed since the UE camped on the current serving cell, but the new value has a value less than one second or is multiplied as a scaling factor to one second so that the UE can reselect a neighbor cell more quickly than one second.
New timer value
   New timer value indicating the time to apply the new speed dependent reselection scaling parameters described above. If a new timer value is included, the UE according to the disclosure can drive a new timer with the new timer value.
Speed threshold value
   If the speed of the UE is greater than a speed threshold, new speed dependent reselection scaling parameters may be applied. Otherwise, typical speed dependent reselection scaling parameters may be applied.

In step 1j-06, the UE 1j-01 receiving the RRC connection release message may transition to RRC idle mode (RRC_IDLE) or RRC inactive mode (RRC_INACTIVE).

In step 1j-10, the UE 1j-01 in RRC idle mode or RRC inactive mode may receive or obtain system information from the base station 1j-02. The system information may include parameters for the UE to perform a cell selection or cell reselection process. This may follow the above-described embodiment. Additionally, the base station 1j-02 may broadcast the system information including new scaling parameters (speedStateReselectionScalingPars) for determining the mobility state of the UE.
κ for t-ReselectionRAT: This parameter refers to a scaling factor for typical t-ReselectionRAT. This parameter is multiplied or added to the typical parameter to enable the UE to perform cell reselection more quickly.
   t-ReselectionRATUAV=t-Reselection+κ or κ×t-ReselectionRAT
α for t-Evaluation: This parameter refers to a scaling factor for typical t-Evaluation. This parameter is multiplied or added to the typical parameter to enable the UE to determine the mobility state more quickly.

$${T}_{CRmaxUAV} = TCR max + α or α \times {T}_{CRmax}$$

β for t-HystNormal: This parameter refers to a scaling factor for typical t-HystNormal. This parameter is multiplied or added to the typical parameter to enable the UE to transition to the normal mobility state more quickly or more slowly.

$${T}_{CRmaxHystUAV} = {T}_{CRmaxHyst} + β or β \times {T}_{CRmaxHyst}$$

γ for n-CellChangeMedium: This parameter refers to a scaling factor for typical n-CellChangeMedium. This parameter is multiplied or added to the typical parameter to enable the UE to enter the medium mobility state more quickly.

$${N}_{CR \_ MUAV} = {N}_{CR \_ MUAV} + γ or γ \times {N}_{CR \_ MUAV}$$

δ for n-CellChangeHigh: This parameter refers to a scaling factor for typical n-CellChangeHigh. This parameter is multiplied or added to the typical parameter to enable the UE to enter the high mobility state more quickly.

$${N}_{CR \_ HUAV} = {N}_{CR \_ HUAV} + δ or δ \times {N}_{CR \_ HUAV}$$

q-HystSFUAV: Speed-based ScalingFactor parameter
   θ for sf-Medium: This parameter refers to a scaling factor for typical parameter sf-Medium. This parameter is multiplied or added to the typical parameter to enable the UE to reselect a neighbor cell more quickly.

$$sf - MediumUAV = sf - Medium + θ or θ \times sf - Medium$$

μ for sf-High: This parameter refers to a scaling factor for typical parameter sf-High. This parameter is multiplied or added to the typical parameter to enable the UE to reselect a neighbor cell more quickly.

$$sf - HighUAV = sf - High + μ or μ \times sf - High$$

t-Reselection-SF (per NR frequency): SpeedStateScaleFactors parameter
   ρ for sf-Medium: This parameter refers to a scaling factor for typical parameter sf-Medium. This parameter is multiplied or added to the typical parameter to enable the UE to reselect a neighbor cell more quickly.

$$sf - MediumUAV = sf - Medium + ρ or ρ \times sf - Medium$$

φ for sf-High; This parameter refers to a scaling factor for typical parameter sf-High. This parameter is multiplied or added to the typical parameter to enable the UE to reselect a neighbor cell more quickly.

$$sf - HighUAV = sf - High + φ or φ \times sf - High$$

t-ReselectionEUTRA-SF (per EUTRA frequency or common for all EUTRA frequencies): SpeedStateScaleFactors parameter
   ω for sf-Medium: This parameter refers to a scaling factor for typical parameter sf-Medium. This parameter is multiplied or added to the typical parameter to enable the UE to reselect a neighbor cell more quickly.

$$sf - MediumUAV = sf - Medium + ω or ω \times sf - Medium$$

τ for sf-High: This parameter refers to a scaling factor for typical parameter sf-High. This parameter is multiplied or added to the typical parameter to enable the UE to reselect a neighbor cell more quickly.

$$sf - HighUAV = sf - High + τ or τ \times sf - High$$

A value or scaling factor indicating how many seconds after the UE camps on the serving cell, cell reselection is possible.
   Typically, reselection to a neighbor cell is possible after one second has elapsed since the UE camped on the current serving cell, but the new value has a value less than one second or is multiplied as a scaling factor to one second so that the UE can reselect a neighbor cell more quickly than one second.
Speed threshold value
   If the speed of the UE is greater than the speed threshold value, new speed dependent reselection scaling parameters may be applied. Otherwise, typical speed dependent reselection scaling parameters may be applied.

In step 1j-15, the UE 1j-01 in RRC idle mode or RRC inactive mode may perform a cell selection or cell reselection process. This can be performed by following the above-described embodiment or by applying at least one of the parameters described above in step 1j-10.

In step 1j-20, the UE 1j-01 in RRC idle mode or RRC inactive mode may determine the mobility state. In the case that the UE supporting UAV acquires new speed dependent reselection scaling parameters in step 1j-05 or step 1j-10, it may determine the mobility state according to predetermined criteria by considering the new speed dependent reselection scaling parameters in addition to the typical speed dependent reselection parameters. For reference, if new speed dependent reselection scaling parameters are configured in step 1j-05, the UE may apply the new speed dependent reselection scaling parameters included in the RRC connection release message. Alternatively, in the case that the UE 1j-01 supporting UAV acquires new speed dependent reselection parameters in step 1j-05 or step 1j-10, it may determine the mobility state according to predetermined criteria based on the new speed dependent reselection scaling parameters depending on the speed threshold value (which may be acquired in step 1j-05 or step 1j-10 or determined directly in the UE).
Medium-mobility state criteria
   If the number of cell reselections during time period T_{CRmax} (or T_{CRmaxUAV}) is greater than or equal to N_{CR_M} (or N_{CR_MUAV}) but less than or equal to N_{CR_H} (or N_{CR_H-UAV})
High-mobility state criteria
   If the number of cell reselections during time period T_{CRmax} (or T_{CRmaxUAV}) is greater than N_{CR_H} (or N_{CR_H-UAV})
Normal-mobility state criteria
   If criteria for either Medium- or High-mobility state is not detected during time period T_{CRmaxHystUAV} or T_{CRmaxHyst}, or if the number of cell reselections during time period T_{CRmaxUAV} (or T_{CRmax}) is less than N_{CR_M} (or N_{CR_MUAV})

The UE may perform a cell reselection process by applying a scaling rule according to the determined mobility state. Specifically,
If neither Medium- nor High-mobility state is detected,
   No scaling is applied.
If high-mobility state is detected,
   Add the sf-HighUAV (or sf-High) of “Speed dependent ScalingFactor for Qhyst” to Qhyst if broadcasted in system information.
   For NR cells, multiply TreselectionNRUAV (or TreselectionNR) by the sf-HighUAV (or sf-High) of “Speed dependent ScalingFactor for TreselectionNRUAV (or TreselectionNR)” if broadcasted in system information.
   For EUTRA cells, multiply TreselectionEUTRAUAV (or TreselectionEUTRA) by the sf-HighUAV (or sf-High) of “Speed dependent ScalingFactor for TreselectionEUTRAUAV (or TreselectionEUTRA)” if broadcasted in system information.
If Medium-mobility state is detected,
   Add the sf-MediumUAV (or sf-Medium) of “Speed dependent ScalingFactor for Qhyst” to Qhyst if broadcasted in system information.
   For NR cells, multiply TreselectionNRUAV (or TreselectionNR) by the sf-Medium UAV (or sf-Medium) of “Speed dependent ScalingFactor for TreselectionNRUAV (or TreselectionNR)” if broadcasted in system information.
   For EUTRA cells, multiply TreselectionEUTRAUAV (or TreselectionEUTRA) by the sf-MediumUAV (sf-Medium) of “Speed dependent ScalingFactor for TreselectionEUTRAUAV (or TreselectionEUTRA)” if broadcasted in system information.

For reference, in the case where the scaling is applied to any TreselectionRAT parameter, the UE shall round up the result after all scalings to the nearest second.

For reference, if a UE that supports UAV or a UE that does not support UAV fails to acquire new speed dependent reselection scaling parameters in step 1j-05 or step 1j-10, it may determine the mobility state based on the above-described embodiment. Also, even if the UE speed is slower than the speed threshold value or if it is equal to or slower than the speed threshold value, the mobility state can be determined using typical speed dependent reselection parameters.

In step 1j-20, the UE may perform the cell reselection process specified in step 1j-15 by reflecting the scaling result according to the determined mobility state.

In step 1j-25, the UE 1j-01 in RRC idle mode or RRC inactive mode may initiate an RRC connection establishment procedure or an RRC connection resume procedure to establish an RRC connection with the base station 1j-02. That is, in step 1j-25, the UE may transmit an RRC connection request message (RRCSetupRequest) or an RRC connection resume request message (RRCResumeRequest or RRCResumeRequest1) to the base station. In step 1j-30, the base station may transmit an RRC connection setup message (RRCSetup) or an RRC connection resume message (RRCResume) to the UE in response to the RRC connection request message or the RRC connection resume request message. The UE that has received the RRC connection setup message or the RRC connection resume message may transition to RRC connected mode (RRC_CONNECTED) in step 1j-31. Then, in step 1j-35, the UE in RRC connected mode may transmit an RRC connection setup complete message (RRCSetupComplete) or an RRC connection resume complete message (RRCResumeComplete) to the base station. At this time, the RRC connection setup complete message or the RRC connection resume complete message may include a UE's new mobility state (mobility state for UAV) or the typical mobility state. Specifically, the RRC connection setup complete message or the RRC connection resume complete message may include the mobilityStateUAV or mobilityState and set it to the mobility state (as specified in TS 38.304) of the UE just prior to entering RRC_CONNECTED state.

According to the disclosure, in the case of a UAV UE, if new speed dependent reselection scaling parameters are broadcasted or configured, the UAV UE can determine the mobility state or perform cell reselection by applying the new speed dependent reselection scaling parameters. Even in the case of the UAV UE, if it does not have the new speed dependent reselection scaling parameters, it can determine the mobility state or perform cell reselection according to the typical method. Alternatively, according to the disclosure, in the case where the UE speed is greater than the speed threshold value, it is possible to determine the mobility state or perform cell reselection by applying the new speed dependent reselection scaling parameters. Even in the case where the UE speed is greater than the speed threshold value, if there are no new speed dependent reselection scaling parameters, it is possible to determine the mobility state or perform cell reselection according to the typical method.

FIG. 1K is a flowchart illustrating a process in which a UE reports a mobility state to an NR base station in a next-generation mobile communication system according to an embodiment of the disclosure.

The UE in the next-generation mobile communication system according to this embodiment may mean a UE capable of receiving uncrewed aerial vehicle (UAV) services. Alternatively, the UE in the next-generation mobile communication system according to this embodiment may mean a UE capable of flying or moving at high speed or a UE capable of applying a newly defined mobility state determination method. The UE capable of receiving UAV services may satisfy the following requirements specified in 3GPP TS 22.125. In particular, the UE can receive UAV services while moving at high speed. In the case of complying with the typical mobility state determination, the UE moving at a high speed may enter the medium mobility state or the high mobility state much later despite its high speed. Accordingly, in this embodiment, a mobility state determination method for the above UE is proposed.

| | | Typical | | Max UAV | | Typical | | | | | Positive |
|---|---|---|---|---|---|---|---|---|---|---|---|
| | | Message | | ground | | message Size | | End to end | | Reliability | ACK |
| Control Mode | Function | Interval | | speed | | (note 1) | | Latency | | (note 2) | (note 8) |
| Steer to | UAV terminated | >=1 | s | 300 | km/h | 100 | byte | 1 | s | 99.9% | Required |
| waypoints | C2 message | | | | | | | | | | |
| (note 3) | UAV originated | 1 | s | | | 84-140 | byte | 1 | s | 99.9% | Not |
| | C2 message | | | | | | | | | | Required |
| | (note 4) | | | | | | | | | | |
| Direct stick | UAV terminated | 40 ms | | 60 | km/h | 24 | byte | 40 | ms | 99.9% | Required |
| steering | C2 message | (note 6) | | | | | | | | | |
| (note 5) | UAV originated | 40 | ms | | | 84-140 | byte | 40 | ms | 99.9% | Not |
| | C2 message | | | | | | | | | | Required |
| | (note 7) | | | | | | | | | | |
| Automatic | UAV terminated | 1 | s | 300 | km/h | <10 | kbyte | 5 s | | 99.9% | Required |
| flight | C2 message | | | | | | | (note 9) | | | |
| on UTM | UAV originated | 1 s | | | | 1500 | byte | 5 s | | 99.9% | Required |
| (note 10) | C2 message | (note 9) | | | | | | (note 9) | | | |
| Approaching | UAV terminated | 500 | ms | 50 | km/h | 4 | kbyte | 10 | ms | 99% | Required |
| Autonomous | C2 message | | | | | | | | | | |
| Navigation | UAVoriginated | 500 | ms | | | 4 | kbyte | 140 | ms | 99.99% | Required |
| Infrastructure | C2 message | | | | | | | | | | |

note 1:
Message size is at the application layer and excludes any headers and security related load. The numbers shown are typical as message size depends on the commands sent and is implementation specific.
note 2:
Message reliability is defined as the probability of successful transmission within the required latency at the application layer while under network coverage.
note 3:
Video is neither required nor expected to be used for steering in this mode.
note 4:
It may be possible to transmit this message on an event driven basis (e.g. approaching a geo fence). A status message may, but is not required to, be sent as a response to a control message.
note 5:
A video feedback is required for this mode. The KPIs for video are defined in table 7.2-2.
note 6:
UAVs on-board controllers typically update at either 50 Hz (20 ms) or 25 Hz (40 ms).
note 7:
A status message may, but is not required to, be sent as a response to a control message A 1kz slow mode also exists.
note 8:
Positive ACK is sent to the originator of the message (i.e. UAV controller and/or the UTM). The 5G system makes no assumption whether an appropriate ACK is sent by the application layer.
note 9:
At the application layer, the C2 communication between a UAV and UTM can be allowed to experience much longer traffic interruptions, e.g. timeouts of 30 s on the uplink and 300 s on the downlink.
note 10:
This only represents periodic message exchange during a nominal mission in steady state. Itdoes not represent unusual or aperiodic events such as conveying dynamic restrictions or a flight plan to the UAV on the downlink.

With reference to FIG. 1K, in step 1k-03, the UE 1k-01 may establish an RRC connection with the NR cell 1k-02 and thus be in RRC connected mode (RRC_CONNECTED).

In step 1k-04, the UE 1k-01 in RRC connected mode may transmit a UE capability information message (UECapabilityInformation) to the NR cell 1k-02. This message may include at least one of the following.
Indicator supporting enhanced mobility state determination
Indicator indicating a UAV UE
Indicator indicating that new speed dependent reselection parameters included in system information or RRC connection release message can be applied

In step 1k-05, the NR cell 1k-02 may transmit an RRC connection release message (RRCRelease) to the UE 1k-01 in RRC connected mode. This message may include new speed dependent reselection parameters or new speed dependent reselection scaling parameters. This may follow the above-described embodiment. In addition, this message may include at least one of the following.
One or more speed threshold values
   In the case that the UE speed is greater than (alternatively, greater than or equal to) the speed threshold value, the UE may enter the medium mobility state or the high mobility state. Specifically, in the case that a plurality of speed threshold values are set, and the UE speed is greater than (alternatively, greater than or equal to) s1, the UE may enter the high mobility state and apply the typical speed dependent reselection parameters or new speed dependent reselection (scaling) parameters. In the case that the UE speed is less than (alternatively, less than or equal to) s1 and greater than (alternatively, greater than or equal to) s2, the UE may enter the medium mobility state and apply the typical speed dependent reselection parameters or new speed dependent reselection (scaling) parameters. In the case that the UE speed is less than (alternatively, less than or equal to) s2, the UE may enter the normal mobility state. In the case that one speed threshold value is set, and the UE speed is greater than (alternatively, greater than or equal to) s1, the UE may enter the high mobility state and apply the typical speed dependent reselection parameters or new speed dependent reselection (scaling) parameters.
New timer value
   Timer value for determining whether the UE speed satisfies the above criteria during the new timer value. That is, if the above criteria are satisfied during the relevant period, the UE may enter the medium mobility state or the high mobility state.

In step 1k-06, the UE 1k-01 receiving the RRC connection release message may transition to RRC idle mode (RRC_IDLE) or RRC inactive mode (RRC_INACTIVE).

In step 1k-10, the UE 1k-01 in RRC idle mode or RRC inactive mode may receive or obtain system information from the base station 1k-02. The system information may include parameters for the UE to perform a cell selection or cell reselection process. This may follow the above-described embodiment. Additionally, the base station 1k-02 may broadcast the system information including new scaling parameters (speedStateReselectionScalingPars or speedStateReselectionPars) for determining the mobility state of the UE. This may follow the above-described embodiment. In addition, the system information may include at least one of the following.
One or more speed threshold values
   In the case that the UE speed is greater than (alternatively, greater than or equal to) the speed threshold value, the UE may enter the medium mobility state or the high mobility state. Specifically, in the case that a plurality of speed threshold values are set, and the UE speed is greater than (alternatively, greater than or equal to) s1, the UE may enter the high mobility state and apply the typical speed dependent reselection parameters or new speed dependent reselection (scaling) parameters. In the case that the UE speed is less than (alternatively, less than or equal to) s1 and greater than (alternatively, greater than or equal to) s2, the UE may enter the medium mobility state and apply the typical speed dependent reselection parameters or new speed dependent reselection (scaling) parameters. In the case that the UE speed is less than (alternatively, less than or equal to) s2, the UE may enter the normal mobility state. In the case that one speed threshold value is set, and the UE speed is greater than (alternatively, greater than or equal to) s1, the UE may enter the high mobility state and apply the typical speed dependent reselection parameters or new speed dependent reselection (scaling) parameters.
New timer value
   Timer value for determining whether the UE speed satisfies the above criteria during the new timer value. That is, if the above criteria are satisfied during the relevant period, the UE may enter the medium mobility state or the high mobility state.

In step 1k-15, the UE 1k-01 in RRC idle mode or RRC inactive mode may perform a cell selection or cell reselection process. This can be performed by following the above-described embodiment or by applying at least one of the parameters described above in step 1k-10.

In step 1k-20, the UE 1k-01 in RRC idle mode or RRC inactive mode may determine the mobility state. In the case that the UE supporting UAV is capable of applying the speed threshold value configured in step 1k-05 or step 1k-10 or is capable of determining the mobility state according to the speed threshold value by itself, it may determine the mobility state by the following predetermined criteria.
Medium-mobility state criteria
   In the case that the UE speed is less than (alternatively, less than or equal to) s1 and greater than (alternatively, greater than or equal to) s2
   Or, when the above criterion is satisfied for the period of the new timer value, transition to the medium mobility state
High-mobility state criteria
   In the case that the UE speed is greater than (alternatively, greater than or equal to) s1
   Or, when the above criterion is satisfied for the period of the new timer value, transition to the high mobility state
Normal-mobility state criteria
   In the case that the UE speed is less than (alternatively, less than or equal to) s2
   Or, in the case that the medium mobility criteria or the high mobility criteria is not satisfied

The UE may perform a cell reselection process by applying a scaling rule according to the determined mobility state. Specifically,
If neither Medium- nor High-mobility state is detected,
   No scaling is applied.
If high-mobility state is detected,
   Add the sf-HighUAV (or sf-High) of “Speed dependent ScalingFactor for Qhyst” to Qhyst if broadcasted in system information.
   For NR cells, multiply TreselectionNRUAV (or TreselectionNR) by the sf-HighUAV (or sf-High) of “Speed dependent ScalingFactor for TreselectionNRUAV (or TreselectionNR)” if broadcasted in system information.
   For EUTRA cells, multiply TreselectionEUTRAUAV (or TreselectionEUTRA) by the sf-HighUAV (or sf-High) of “Speed dependent ScalingFactor for TreselectionEUTRAUAV (or TreselectionEUTRA)” if broadcasted in system information.
If Medium-mobility state is detected,
   Add the sf-MediumUAV (or sf-Medium) of “Speed dependent ScalingFactor for Qhyst” to Qhyst if broadcasted in system information.
   For NR cells, multiply TreselectionNRUAV (or TreselectionNR) by the sf-Medium UAV (or sf-Medium) of “Speed dependent ScalingFactor for TreselectionNRUAV (or TreselectionNR)” if broadcasted in system information.
   For EUTRA cells, multiply TreselectionEUTRAUAV (or TreselectionEUTRA) by the sf-MediumUAV (sf-Medium) of “Speed dependent ScalingFactor for TreselectionEUTRAUAV (or TreselectionEUTRA)” if broadcasted in system information.

For reference, in the case where the scaling is applied to any TreselectionRAT parameter, the UE shall round up the result after all scalings to the nearest second.

In step 1k-20, the UE may perform the cell reselection process specified in step 1k-15 by reflecting the scaling result according to the determined mobility state.

In step 1k-25, the UE 1k-01 in RRC idle mode or RRC inactive mode may initiate an RRC connection establishment procedure or an RRC connection resume procedure to establish an RRC connection with the base station 1k-02. That is, in step 1k-25, the UE may transmit an RRC connection request message (RRCSetupRequest) or an RRC connection resume request message (RRCResumeRequest or RRCResumeRequest1) to the base station. In step 1k-30, the base station may transmit an RRC connection setup message (RRCSetup) or an RRC connection resume message (RRCResume) to the UE in response to the RRC connection request message or the RRC connection resume request message. The UE that has received the RRC connection setup message or the RRC connection resume message may transition to RRC connected mode (RRC_CONNECTED) in step 1k-31. Then, in step 1k-35, the UE in RRC connected mode may transmit an RRC connection setup complete message (RRCSetupComplete) or an RRC connection resume complete message (RRCResumeComplete) to the base station. At this time, the RRC connection setup complete message or the RRC connection resume complete message may include a UE's new mobility state (mobility state for UAV) or the typical mobility state. Specifically, the RRC connection setup complete message or the RRC connection resume complete message may include the mobilityStateUAV or mobilityState and set it to the mobility state (as specified in TS 38.304) of the UE just prior to entering RRC_CONNECTED state.

According to the disclosure, the speed of the UE can be used to determine the mobility state or perform cell reselection according to the speed threshold value.

FIG. 1L is a flowchart illustrating a process in which a UE reports flight path information to an NR base station through an RRC connection resume procedure in a next-generation mobile communication system according to an embodiment of the disclosure.

The UE in the next-generation mobile communication system according to this embodiment may mean a UE capable of receiving uncrewed aerial vehicle (UAV) services. Alternatively, the UE in the next-generation mobile communication system according to this embodiment may mean a UE capable of flying or reporting flight path information.

With reference to FIG. 1L, in step 1l-03, the UE 1l-01 may establish an RRC connection with the NR cell 1l-02 and thus be in RRC connected mode (RRC_CONNECTED).

In step 1l-04, the UE 1l-01 in RRC connected mode may transmit a UE capability information message (UECapabilityInformation) to the NR cell 1l-02. This message may include at least one of the following.
Indicator indicating a UAV UE
Indicator indicating that flight path information can be reported

In step 1l-05, the NR cell 1l-02 may transmit an RRC connection release message (RRCRelease) to the UE 1l-01 in RRC connected mode, so that the UE can transition to RRC inactive mode (RRC_INACTIVE) in step 1l-06.

In step 1l-10, the UE 1l-01 in RRC inactive mode may initiate an RRC connection resume procedure and transmit an RRC connection resume request message (RRCResumeRequest or RRCResumeRequest1) to the NR cell 1l-02.

In step 1l-15, the NR cell 1l-02 may transmit an RRC connection resume message (RRCResume) to the UE 1l-02. In the disclosure, this message may include an indicator (flightPathInfoReq) to report the flight path information.

In step 1l-16, the UE 1l-01 may transition to RRC connected mode by applying the RRC connection resume message.

In step 1l-20, the UE 1l-01 in RRC connected mode may transmit an RRC connection resume complete message (RRCResumeComplete) to the NR cell 1l-02. This message may include flight path information (flightPathInfoReport). Additionally, a time value (timeStamp) for each flight path may be included. That is, it may mean information about which point to arrive at what time. Of course, the UE may include an indicator (flightPathInfoAvailable) that there is flight path information in the RRCResumeComplete.

FIG. 1M is a block diagram illustrating the structure of a UE according to an embodiment of the disclosure.

With reference to FIG. 1M, the UE includes a radio frequency (RF) processor 1m-10, a baseband processor 1m-20, a storage 1m-30, and a controller 1m-40.

The RF processor 1m-10 performs functions of transmitting and receiving signals via radio channels, such as band conversion and amplification of the signals. That is, the RF processor 1m-10 up-converts a baseband signal provided from the baseband processor 1m-20, into an RF band signal and then transmits the RF band signal via an antenna, and down-converts an RF band signal received via the antenna, into a baseband signal. For example, the RF processor 1m-10 may include a transmission filter, a reception filter, an amplifier, a mixer, an oscillator, a digital-to-analog convertor (DAC), an analog-to-digital convertor (ADC), or the like. Although only one antenna is illustrated in FIG. 1M, the UE may include a plurality of antennas. Also, the RF processor 1m-10 may include a plurality of RF chains. In addition, the RF processor 1m-10 may perform beamforming. For beamforming, the RF processor 1m-10 may respectively adjust phases and intensities of signals to be transmitted or received via a plurality of antennas or antenna elements. Also, the RF processor 1m-10 may perform a MIMO operation and may receive a plurality of layers in the MIMO operation.

The baseband processor 1m-20 converts between a baseband signal and a bitstream based on physical entity specifications of a system. For example, upon data transmission, the baseband processor 1m-20 generates complex symbols by encoding and modulating a transmission bitstream. Upon data reception, the baseband processor 1m-20 reconstructs a received bitstream by demodulating and decoding a baseband signal provided from the RF processor 1m-10. For example, in the case of complying with an orthogonal frequency division multiplexing (OFDM) scheme, upon data transmission, the baseband processor 1m-20 generates complex symbols by encoding and modulating a transmit bitstream, maps the complex symbols to subcarriers, and then configures OFDM symbols by performing inverse fast Fourier transform (IFFT) and cyclic prefix (CP) insertion. Upon data reception, the baseband processor 1m-20 segments a baseband signal provided from the RF processor 1m-10, into OFDM symbol units, reconstructs signals mapped to subcarriers by performing fast Fourier transform (FFT), and then reconstructs a received bitstream by demodulating and decoding the signals.

The baseband processor 1m-20 and the RF processor 1m-10 transmit and receive signals as described above. Accordingly, the baseband processor 1m-20 and the RF processor 1m-10 may also be called a transmitter, a receiver, a transceiver, or a communicator. In addition, at least one of the baseband processor 1m-20 or the RF processor 1m-10 may include a plurality of communication modules to support a plurality of different radio access technologies. Also, at least one of the baseband processor 1m-20 or the RF processor 1m-10 may include different communication modules to process signals of different frequency bands. For example, the different radio access technologies may include wireless LAN (e.g., IEEE 802.11), cellular network (e.g., LTE), etc. Also, the different frequency bands may include a super-high frequency (SHF) (e.g., 2.NRHz, NRHz) band and a millimeter wave (mmWave) (e.g., 60 GHz) band.

The storage 1m-30 stores basic programs, application programs, and data, e.g., configuration information, for operations of the UE. In particular, the storage 1m-30 may store information related to a second access node that performs wireless communication using a second radio access technology. And, the storage 1m-30 provides the stored data upon request by the controller 1m-40.

The controller 1m-40 controls overall operations of the UE. For example, the controller 1m-40 transmits and receives signals through the baseband processor 1m-20 and the RF processor 1m-10. Also, the controller 1m-40 records and reads data on or from the storage 1m-30. To this end, the controller 1m-40 may include at least one processor. For example, the controller 1m-40 may include a communication processor (CP) for controlling communications and an application processor (AP) for controlling an upper layer such as an application program.

FIG. 1N is a block diagram illustrating the structure of an NR base station according to an embodiment of the disclosure.

With reference to FIG. 1N, the base station may include a RF processor 1n-10, a baseband processor 1n-20, a backhaul communicator 1n-30, a storage 1n-40, and a controller 1n-50.

The RF processor 1n-10 performs functions of transmitting and receiving signals via radio channels, e.g., band conversion and amplification of the signals. That is, the RF processor 1n-10 up-converts a baseband signal provided from the baseband processor 1n-20, into an RF band signal and then transmits the RF band signal via an antenna, and down-converts an RF band signal received via an antenna, into a baseband signal. For example, the RF processor 1n-10 may include a transmission filter, a reception filter, an amplifier, a mixer, an oscillator, a DAC, an ADC, or the like. Although only one antenna is illustrated in FIG. 1N, a first access node may include a plurality of antennas. Also, the RF processor 1n-10 may include a plurality of RF chains. In addition, the RF processor 1n-10 may perform beamforming. For beamforming, the RF processor 1n-10 may respectively adjust phases and intensities of signals to be transmitted or received via a plurality of antennas or antenna elements. The RF processor may perform a downlink MIMO operation by transmitting one or more layers.

The baseband processor 1n-20 converts between a baseband signal and a bitstream based on physical entity specifications of a radio access technology. For example, upon data transmission, the baseband processor 1n-20 generates complex symbols by encoding and modulating a transmission bitstream. Also, upon data reception, the baseband processor 1n-20 reconstructs a received bitstream by demodulating and decoding a baseband signal provided from the RF processor 1n-10. For example, in the case of complying with the OFDM scheme, upon data transmission, the baseband processor 1n-20 generates complex symbols by encoding and modulating a transmission bitstream, maps the complex symbols to subcarriers, and then configures OFDM symbols by performing IFFT and CP insertion. Also, upon data reception, the baseband processor 1n-20 segments a baseband signal provided from the RF processor 1n-10, into OFDM symbol units, reconstructs signals mapped to subcarriers by performing FFT, and then reconstructs a received bitstream by demodulating and decoding the signals. The baseband processor 1n-20 and the RF processor 1n-10 transmits and receives signals as described above. Accordingly, the baseband processor 1n-20 and the RF processor 1n-10 may also be called a transmitter, a receiver, a transceiver, a communicator, or a wireless communicator.

The backhaul communicator 1n-30 provides an interface for communicating with other nodes in the network. That is, the backhaul communicator 1n-30 converts a bitstream transmitted from the main base station to any other node, for example, an auxiliary base station, a core network, etc., into physical signals, and converts physical signals received from such other node into a bitstream.

The storage 1n-40 stores basic programs, application programs, and data, e.g., configuration information, for operations of the main base station. In particular, the storage 1n-40 may store, for example, information about bearers assigned for a connected UE and measurement results reported from the connected UE. Also, the storage 1n-40 may store criteria information used to determine whether to provide or release dual connectivity to or from the UE. The storage 1n-40 may provide the stored data upon request by the controller 1n-50.

The controller 1n-50 may control overall operations of the main base station. For example, the controller 1n-50 transmits and receives signals through the baseband processor 1n-20 and the RF processor 1n-10, or the backhaul communicator 1n-30. Also, the controller 1n-50 records and reads data on or from the storage 1n-40. To this end, the controller 1n-50 may include at least one processor.

1. A method performed by a terminal in a wireless communication system, the method comprising:
receiving, from a base station, a message including parameters for determining a mobility state of the terminal;
identifying, in the message, information for determining the mobility state of an uncrewed aerial vehicle (UAV) terminal; and
determining the mobility state of the terminal based on the information for determining the mobility state of the UAV terminal.

2. The method of claim 1, wherein the message includes a first parameter set for determining the mobility state of a normal terminal and a second parameter set for determining the mobility state of the UAV terminal.

3. The method of claim 1, wherein the message includes a parameter set for determining the mobility state of a normal terminal and a scaling factor for determining the mobility state of the UAV terminal, and
wherein the scaling factor for determining the mobility state of the UAV terminal is applied to the parameter set.

4. The method of claim 1, wherein the message includes at least one of a radio resource control (RRC) connection release message or a system information block (SIB) message.

5. The method of claim 1, further comprising:
transmitting the determined mobility state of the terminal to the base station.

6. A terminal in a wireless communication system, the terminal comprising:
a transceiver transmitting and receiving a signal; and
a controller configured to:
receive, from a base station, a message including parameters for determining a mobility state of the terminal,
identify, in the message, information for determining the mobility state of an uncrewed aerial vehicle (UAV) terminal, and
determine the mobility state of the terminal based on the information for determining the mobility state of the UAV terminal.

7. The terminal of claim 6, wherein the message includes a first parameter set for determining the mobility state of a normal terminal and a second parameter set for determining the mobility state of the UAV terminal.

8. The terminal of claim 6, wherein the message includes a parameter set for determining the mobility state of a normal terminal and a scaling factor for determining the mobility state of the UAV terminal, and
wherein the scaling factor for determining the mobility state of the UAV terminal is applied to the parameter set.

9. The terminal of claim 6, wherein the message includes at least one of a radio resource control (RRC) connection release message or a system information block (SIB) message.

10. The terminal of claim 6, wherein the controller is further configured to transmit the determined mobility state of the terminal to the base station.

11. A method performed by a base station in a wireless communication system, the method comprising:
transmitting, to a terminal, a message including parameters for determining a mobility state of the terminal; and
receiving, from the terminal, the mobility state of the terminal,
wherein the received mobility state of the terminal is determined based on information for determining the mobility state of an uncrewed aerial vehicle (UAV) terminal in the message by the terminal.

12. The method of claim 11, wherein the message includes a first parameter set for determining the mobility state of a normal terminal and a second parameter set for determining the mobility state of the UAV terminal.

13. The method of claim 11, wherein the message includes a parameter set for determining the mobility state of a normal terminal and a scaling factor for determining the mobility state of the UAV terminal, and
wherein the scaling factor for determining the mobility state of the UAV terminal is applied to the parameter set.

14. The method of claim 11, wherein the message includes at least one of a radio resource control (RRC) connection release message or a system information block (SIB) message.

15. A base station in a wireless communication system, the base station comprising:
a transceiver transmitting and receiving a signal; and
a controller configured to:
transmit, to a terminal, a message including parameters for determining a mobility state of the terminal, and
receive, from the terminal, the mobility state of the terminal,
wherein the received mobility state of the terminal is determined based on information for determining the mobility state of an uncrewed aerial vehicle (UAV) terminal in the message by the terminal.
